(19) United States
(12) Patent Application Publication
(10) Pub. No.: US 2009/0123854 A1
(43) Pub. Date: May 14, 2009

(54) IMAGE FORMING METHOD

(75) Inventors: Akihiko ITAMI, Tokyo (JP); Eiichi SAKAI, Kanagawa (JP); Yoshihiko ETO, Tokyo (JP); Takeo OSHIBA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/266,255

(22) Filed: Nov. 6, 2008

(30) Foreign Application Priority Data
Nov. 14, 2007 (JP) 2007295311

(51) Int. Cl. G03G 13/04

(52) U.S. Cl. 430/48

(57) ABSTRACT

An electrophotographic image forming method is disclosed, wherein a cylindrical developing sleeve carrying a developer is brought into contact with a photoreceptor with rotating the developing sleeve in the counter direction to the rotation of the photoreceptor, and a lubricant is supplied to the photoreceptor and the photoreceptor comprises a uppermost surface layer containing a polyarylate having a structure unit represented by the following formula and the toner comprises toner particles exhibiting a glass transition temperature of from 16 to 44° C.

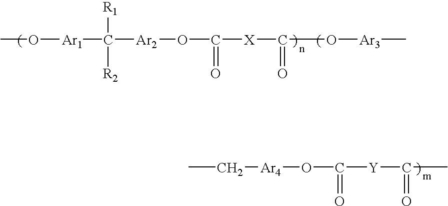

### FIELD OF THE INVENTION

The present invention relates to an image forming method.

### BACKGROUND OF THE INVENTION

In the market of color POD, there has increased desire for low temperature fixing of toners toward energy saving as well as enhancement of image quality and speed Setting a glass transition temperature (hereinafter, also denoted simply as Tg) of a toner resin as low as possible is effective for lowering the fixing temperature. As is known, however, problems arise with the use of a toner of a low Tg such that toner filming is easily caused on an electrophotographic photoreceptor (hereinafter, also denoted simply as a photoreceptor). It is known as a means for preventing toner filming to supply a lubricant onto the photoreceptor surface to achieve enhanced releasability from the surface. Such a technique may prevent filming of a toner itself but there are problems such that it is difficult to prevent paper powder which is difficult to remove by a cleaning blade or microparticles of external additives added to the toner from adhering onto the photoreceptor.

Electrophotographic photoreceptors are repeatedly used in the electrophotographic process in a cycle of charging, exposure, development, transfer, cleaning and charge-neutralization and are subject to various stresses in the meantime, leading to deterioration of the receptors. Examples of such deterioration include chemical or electrical deterioration such that strongly oxidative ozone or NOₓ generated from a corona charger used as a conventional charger chemically damages the light-sensitive layer, carriers (electric current) formed upon imagewise exposure flow into the light-sensitive layer or a photosensitive composition is decomposed by external light Further, examples of mechanical deterioration include wearing of a cleaning brush or a magnetic brush, and abrasion or flaws of the light-sensitive layer surface and its peeling-off, which are due to contact with the developer or paper. Specifically, such damage formed on the photoreceptor surface easily occur on copied images and directly vitiate image quality, leading to factors limiting the lifetime of a photoreceptor. Thus, enhancement of mechanical strength as well as electrical and chemical durability are essential for development of a long-lived electrophotographic photoreceptor.

Generally, in the case of a layered photoreceptor, a charge transport layer is subjected to such a load. A charge transport layer is usually comprised of a binder resin and a charge transport material, in which the binder resin substantially determines the strength. However, since the doping amount of the charge transport material is large, sufficient mechanical strength has not yet been achieved. Further, enhanced desire for high-speed printing requires materials responding to a high-speed electrophotographic process. In that case, an electrophotographic photoreceptor is required to not only be high-sensitive and long-lived but also enhanced responsibility to shorten the time of from exposure to development. As is known, responsibility of a photoreceptor is controlled by the charge transport layer, specifically, the charge transport material but is also greatly variable by the binder resin.

Examples of a binder resin used for a charge transport layer include a vinyl polymer such as poly(methyl methacrylate), polystyrene or polyvinyl chloride) and its copolymer; a thermoplastic resin such as polycarbonate, polyester, polysulfone, or phenoxy, epoxy or silicone resin; and various thermo-setting resin. Of these polymers, polycarbonate resin exhibits relatively good performance and various kinds of polycarbonate resins have been used in practice.

There was recently disclosed a poly arylate resin used for a binder resin of a charge transport layer and suitable for a long-life photoreceptor, as set forth in JP-A 2000-41627 and 2007-122076 (hereinafter, JP-A refers to Japanese Patent Application Publication). Such polyarylate resin provides a high-sensitive and long-life electrophotographic photoreceptor but it was proved that a low Tg toner caused deposition of microparticles on the photoreceptor surface.

### SUMMARY OF THE INVENTION

It is an object of the invention to provide an image forming method which can inhibit a phenomenon of deposition of microparticles on the surface of an electrophotographic photoreceptor even when a low Tg toner in the presence of a lubricant and an electrophotographic photoreceptor used therein.

As a result of extensive study of the foregoing problems, it was found that even when using a low Tg toner in the presence of a lubricant, deposition of microparticles on the photoreceptor surface was prevented by counter-rotation of a development sleeve and the use of a photoreceptor of a specific polyarylate.

Thus, one aspect of the invention is directed to an image forming method comprising the steps of (a) electrical-charging a cylindrical photoreceptor, (b) forming an electrostatic latent image on the charged photoreceptor, (c) developing the electrostatic latent image formed on the photoreceptor with a developer comprising a toner to form a toner image, (d) transferring the toner image to a transfer medium and (e) removing a residual toner on the photoreceptor to clean the photoreceptor, wherein in step (c), a cylindrical developing sleeve carrying a developer is brought into contact with the photoreceptor while rotating the developing sleeve in the counter direction to the rotation of the photoreceptor, and a lubricant is supplied to the photoreceptor and the photoreceptor comprises a uppermost surface layer containing a polyarylate having a structure unit represented by the following formula (1) and the toner comprises toner particles exhibiting a glass transition temperature (Tg) of from 16 to 44° C.:

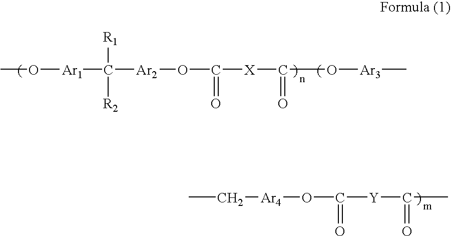

wherein Ar₁ to Ar₄ are each an unsubstituted or substituted phenylene group; X and Y are each a divalent linkage group selected from the group of a divalent saturated or unsaturated aliphatic hydrocarbon group, an unsubstituted or substituted phenylene group, an unsubstituted or substituted naphthylene group and an unsubstituted or substituted biphenylene group; R₁ and R₂ are each a hydrogen atom, an unsubstituted or substituted alkyl group, an unsubstituted or substituted aryl group, an unsubstituted or substituted acyloxy group or an unsubstituted or substituted arylsulfoxy group, provided that R₁ and R₂ may combine with each other to form a ring; n is an integer of 30 to 400 and m is an integer of 0 to 200, provided that when m is not 0, a repeating unit enclosed by n in a parenthesis, i.e., —O—Ar₁—C(R₁)(R₂)Ar₂—O—OC(═O)—X—C(═O)— and a repeating unit enclosed by m in a parenthesis, i.e., —O—Ar₃—CH₂—Ar₄—O—C(═O)—Y—C(═O)— are not the same.

According to the invention, even when using a low Tg toner in the presence of a lubricant, deposition of microparticles on the photoreceptor surface was prevented by rotation of a development sleeve in the counter direction and by the use of a photoreceptor of a specific polyarylate.

### BRIEF DESCRIPTION OF THE DRAWINGS

FIG. 1 illustrates a sectional view of a developing device according to the counter development method.

FIG. 2 illustrates an electrophotographic image forming apparatus having a process cartridge.

FIG. 3 illustrates a sectional view of a color image forming apparatus showing one of the embodiments of the invention.

FIG. 4 illustrates a sectional view of a color image forming apparatus employing an organic photoconductor relating to the invention.

FIG. 5 illustrates constitution of a cleaning means related to the invention.

### DETAILED DESCRIPTION OF THE INVENTION

### Compound Of Formula (1)

In the formula (1), Ar₁ to Ar₄ each represents an unsubstituted group or a substituted phenylene group which is substituted by a substituent. Such a substituent is preferably at least one selected from the group consisting of a halogen atom, a cyano group, a nitro group, a hydrocarbon group, a halogen atom-substituted hydrocarbon group, and an alkylthio group; and more preferably a hydrocarbon group.

X and Y are each independently a divalent linkage group selected from the group consisting of a divalent, saturated or unsaturated aliphatic hydrocarbon group which may be substituted, a phenylene group which may be substituted, a naphthylene group which may be substituted and a biphenylene group which may be substituted.

Such a divalent linkage group represented by X or Y is preferably a divalent, saturated or unsaturated hydrocarbon group having 2 to 6 carbon atoms which is unsubstituted or substituted by a substituent selected from the group consisting of a fluorine atom, a chlorine atom, a bromine atom, a methyl group, a methoxy group, trifluoromethyl group and a trifluoromethoxy group; or a phenylene, naphthylene or biphenylene group which is unsubstituted or substituted by a substituent selected from the group consisting of a hydrocarbon group substituted by a halogen atom, an alkoxy group, an alkoxy group substituted by a halogen atom and an alkylthio group.

In the formula (1), n is an integer of from 30 to 400 and m is an integer of from 0 to 200, provided that when m is not 0, a repeating unit enclosed by n in a parenthesis [corresponding to a repeating unit represented by —O—Ar₁—C(R₁)(R₂) Ar₂—O—OC(═O) —X—C(═O)—] and a repeating unit enclosed by m in a parenthesis [corresponding to a repeating unit represented by —O—Ar₃—CH₂—Ar₄—O—C(═O)—Y—C(═O)—] are not the same with each other.

Specific examples of the compound represented by the formula (1) include those described in, for example, JP-A 2007-122076 (paragraph 0106-0128), as shown below.

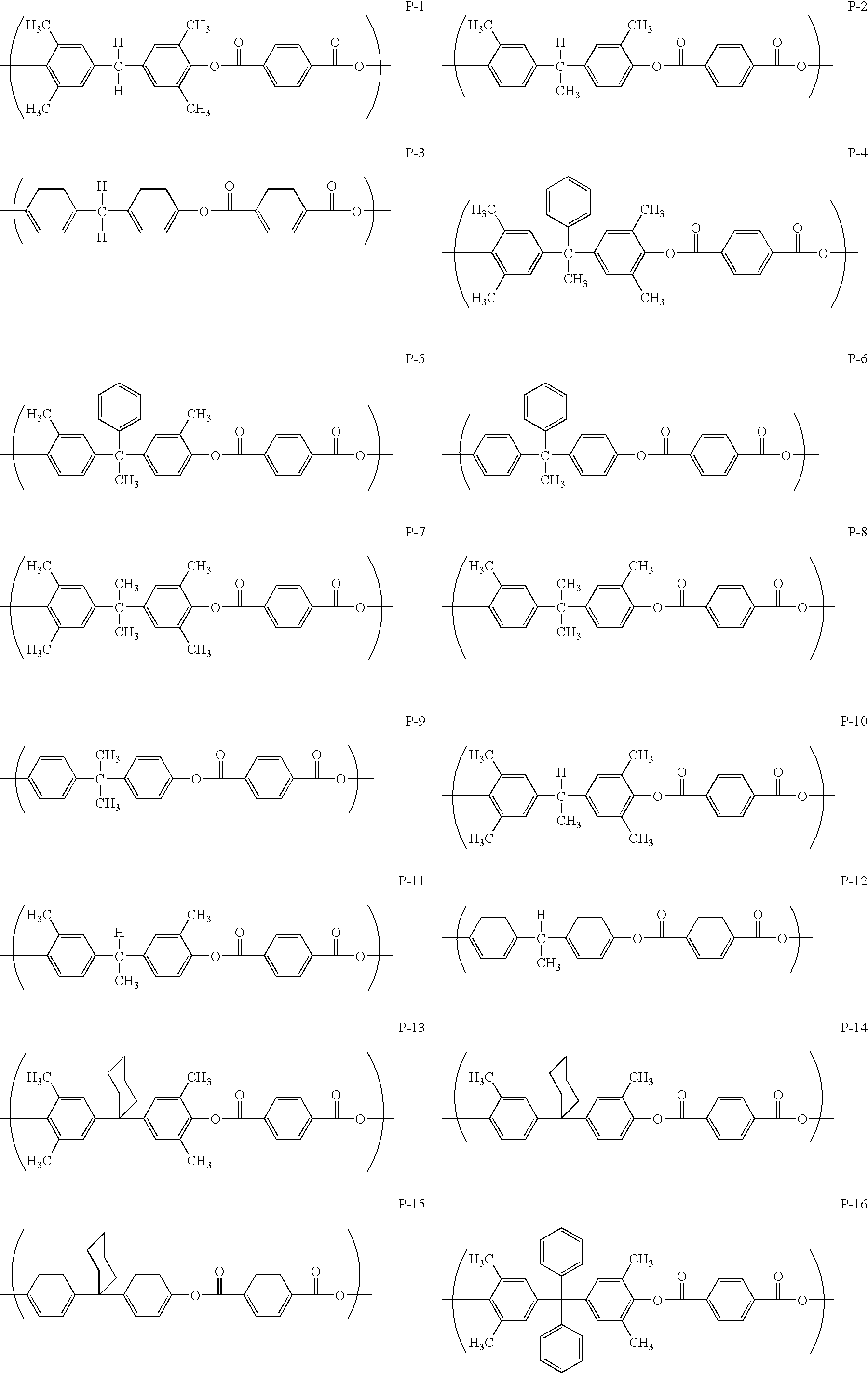

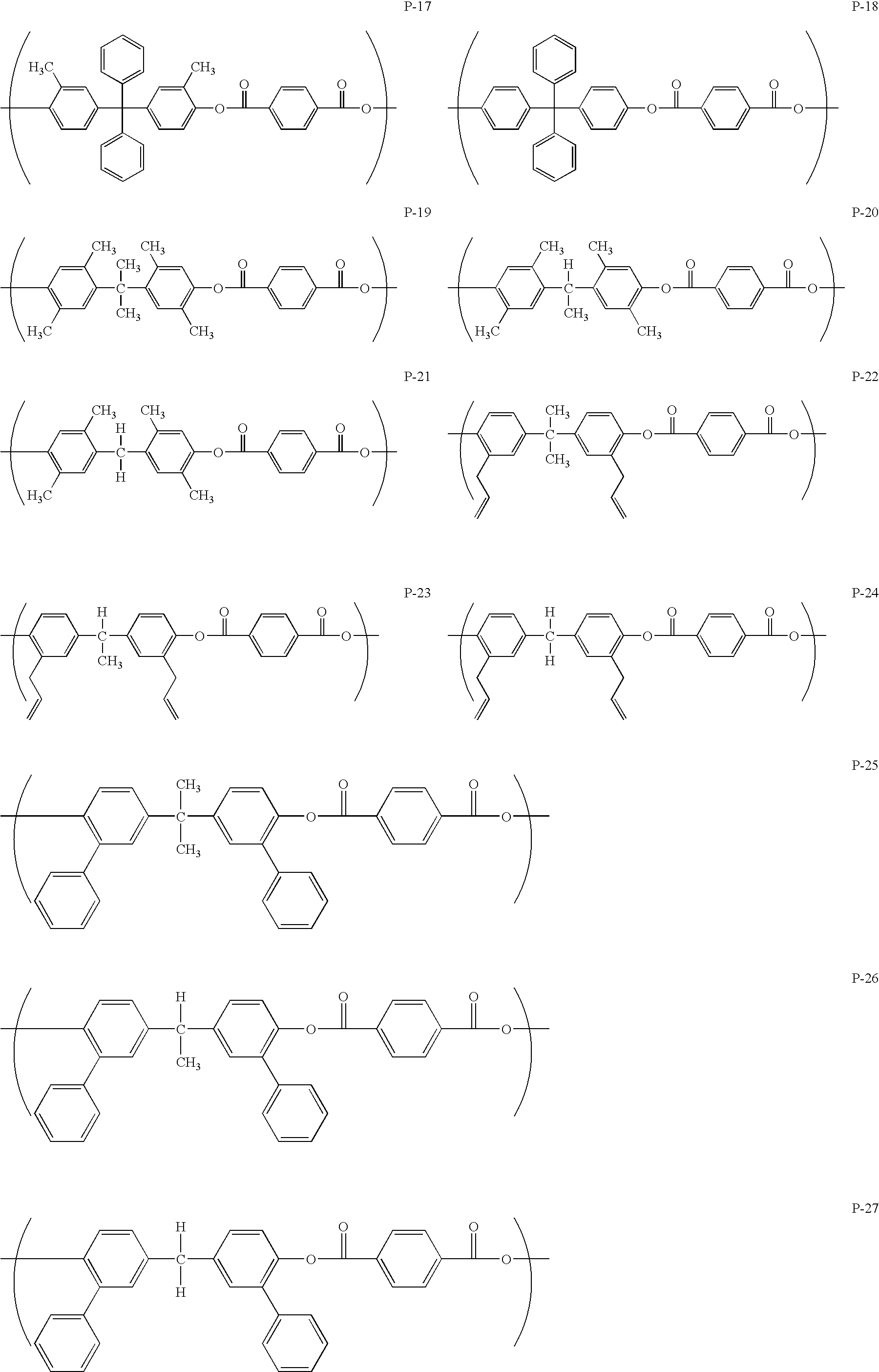

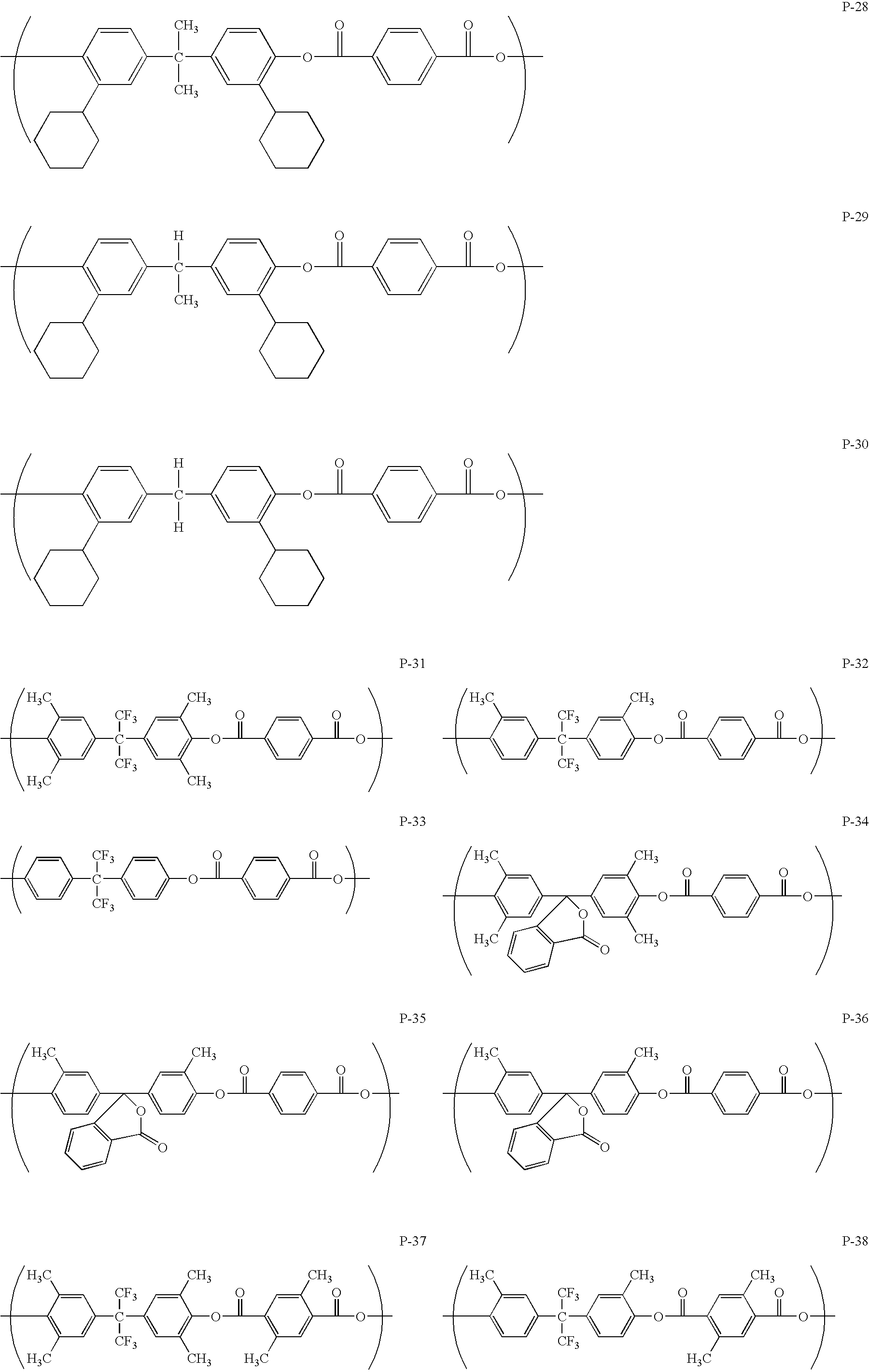

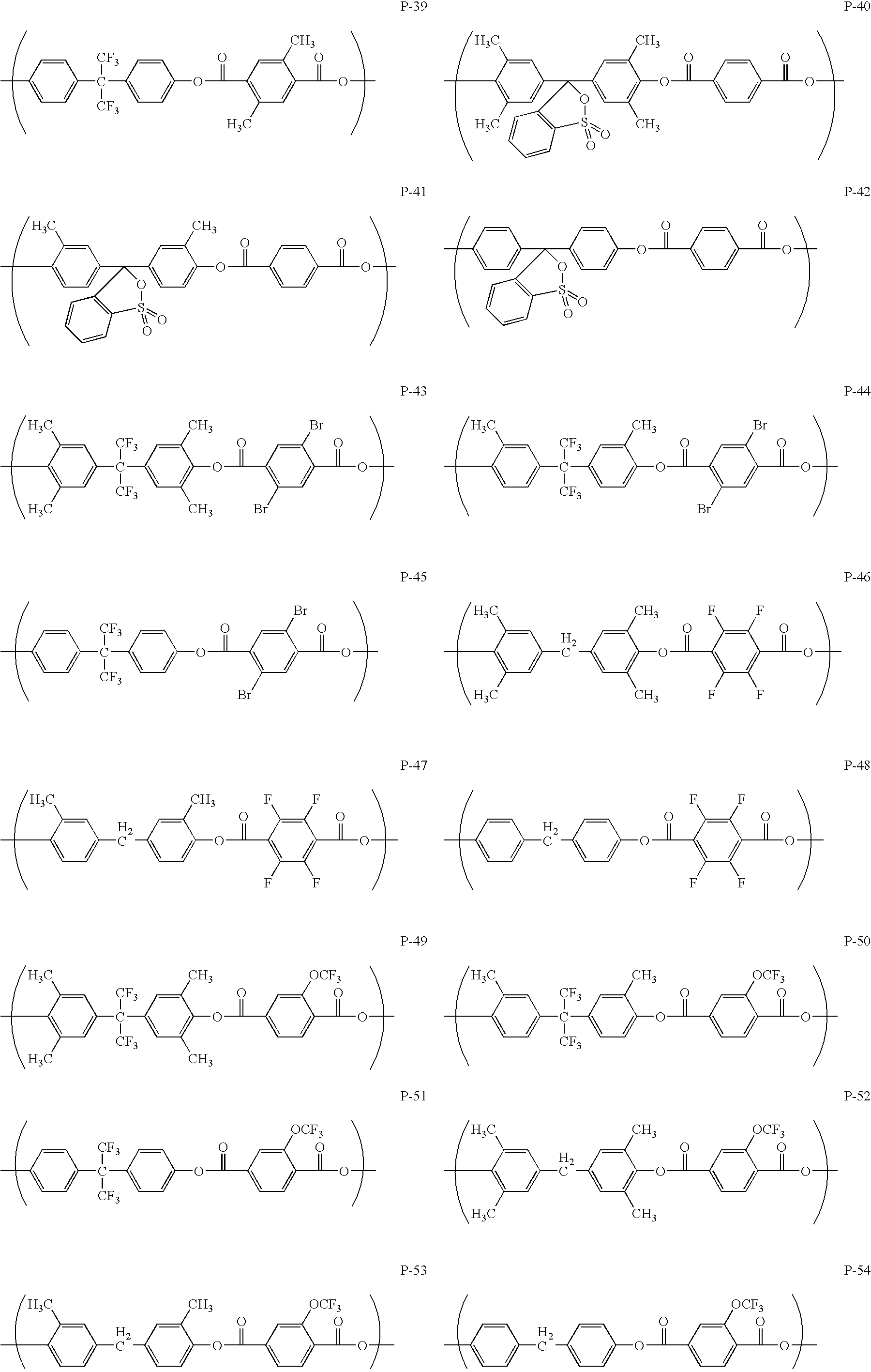

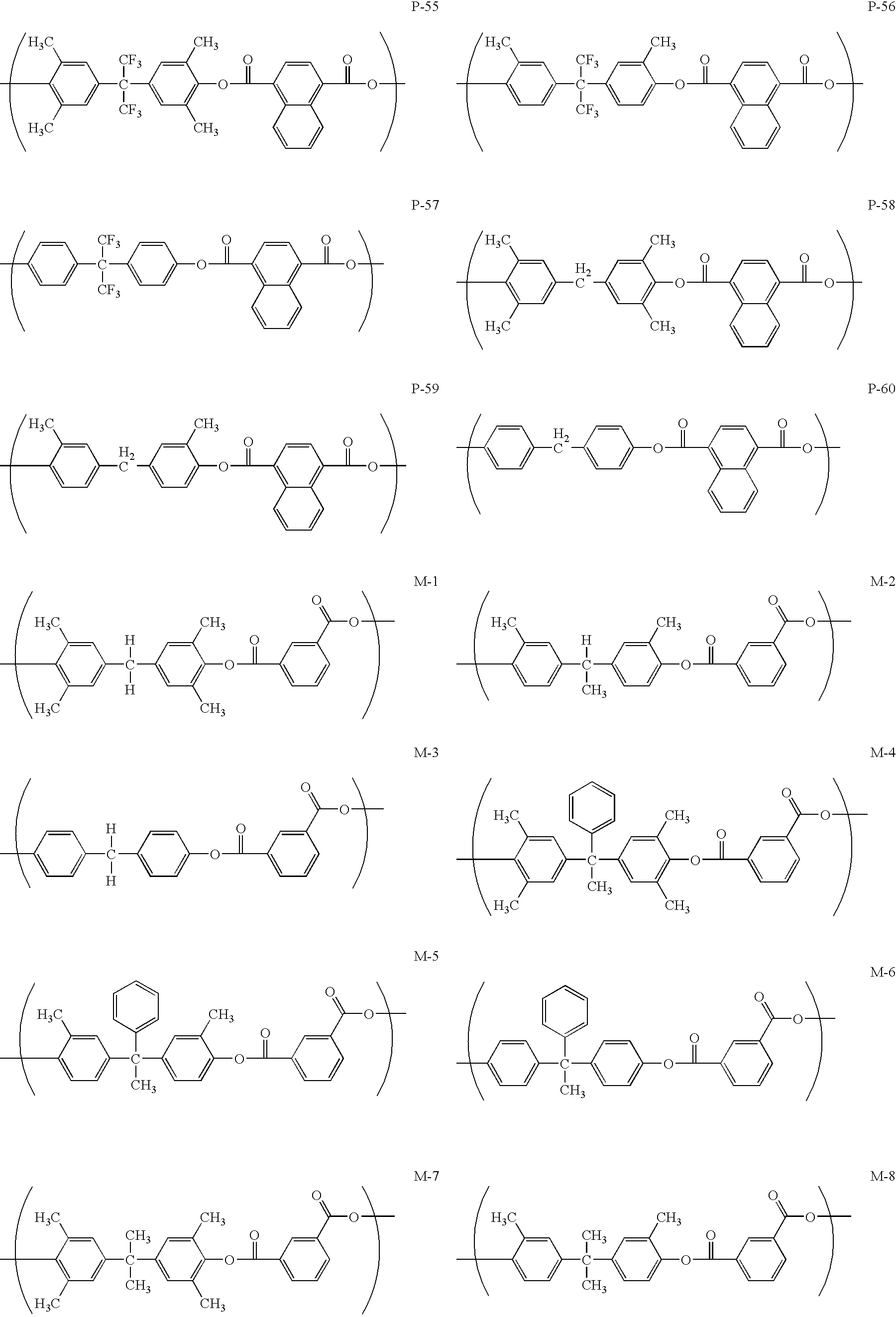

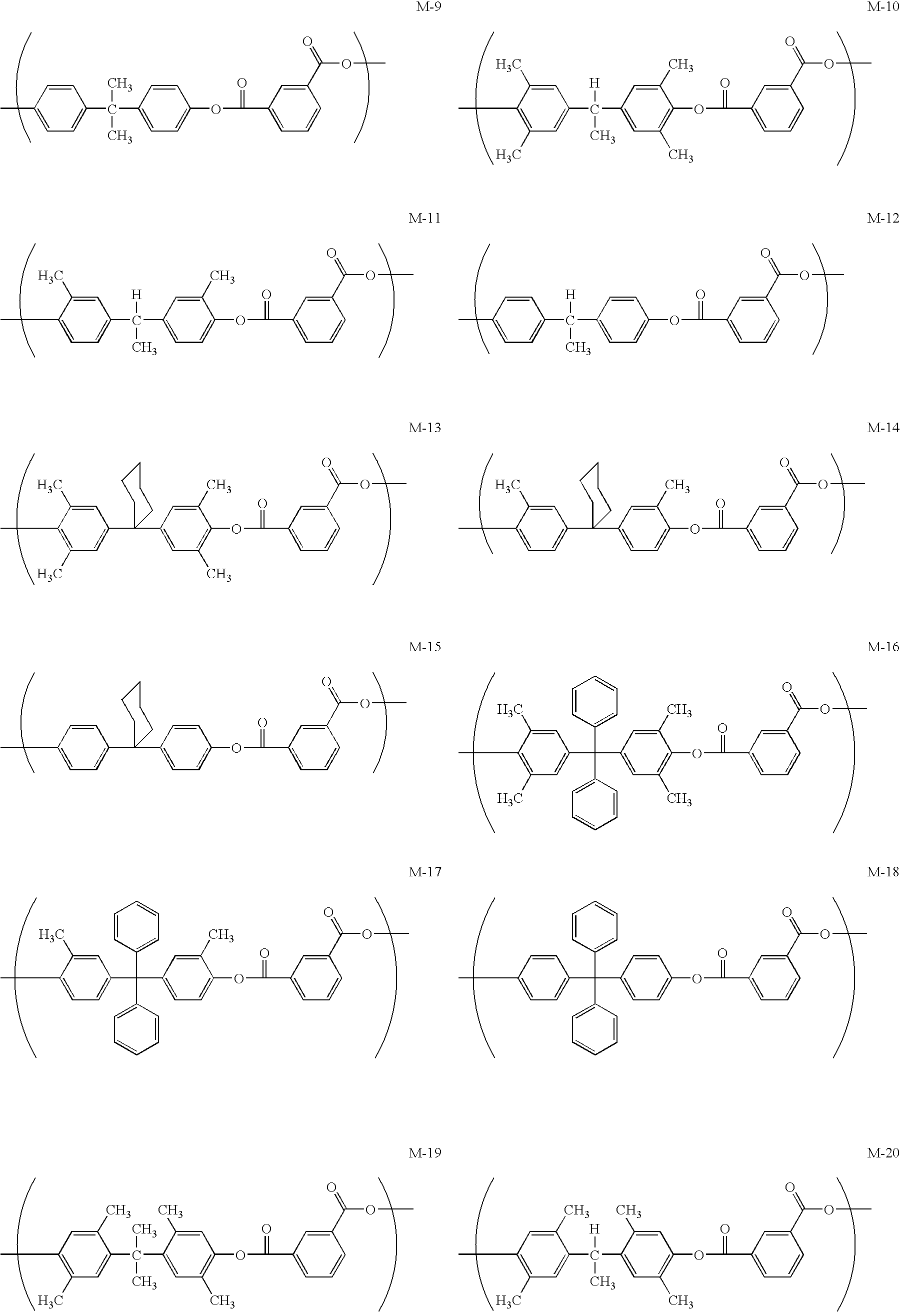

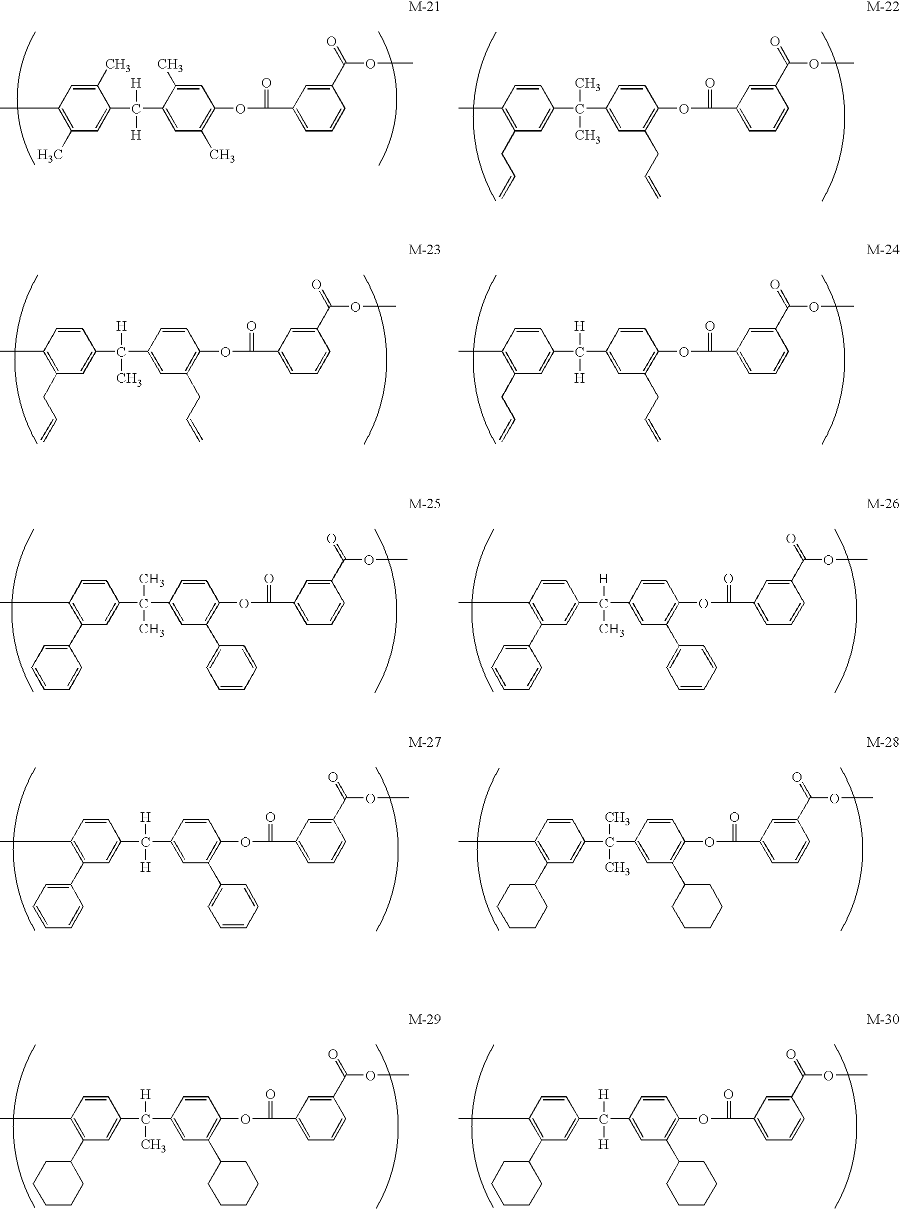

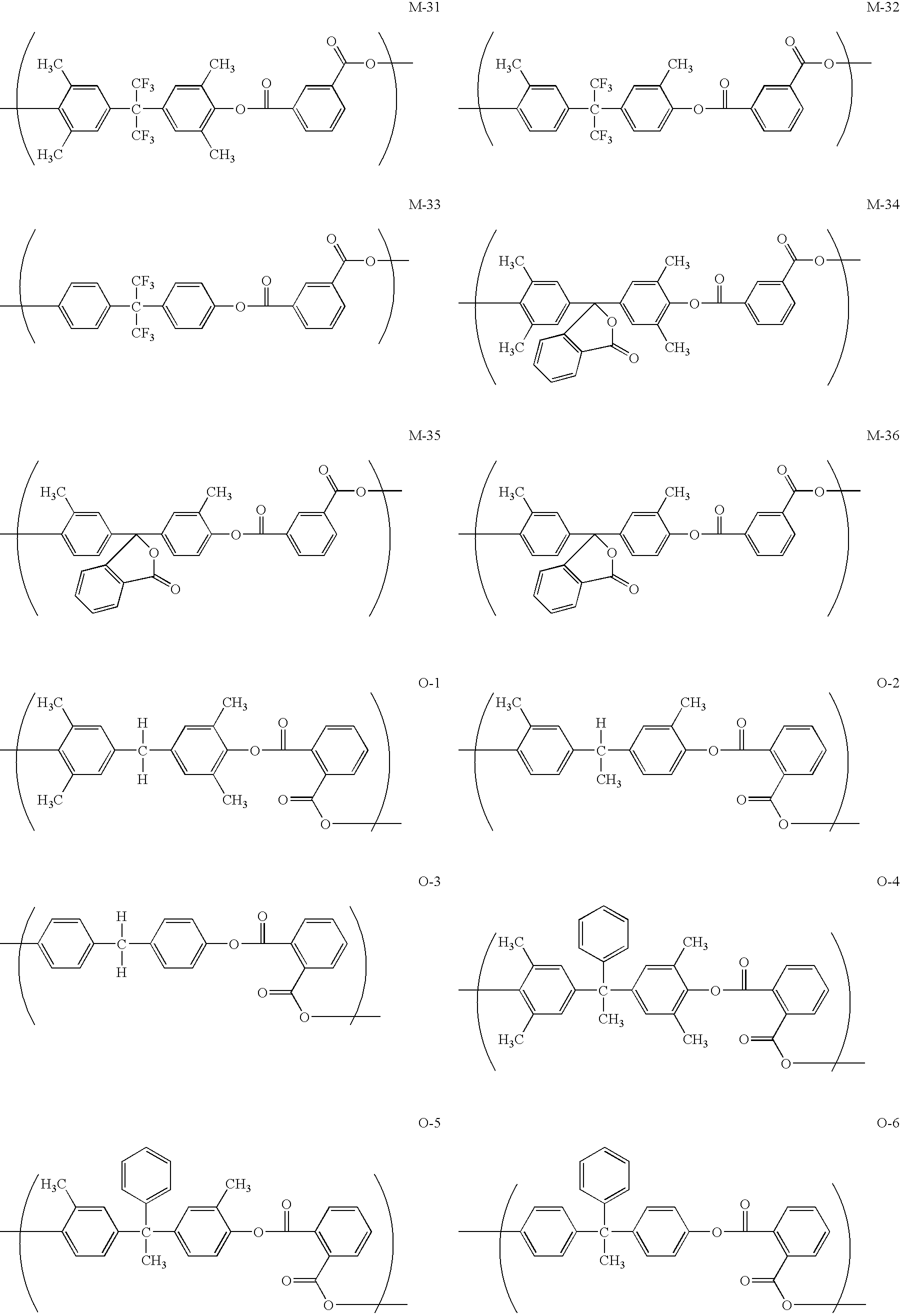

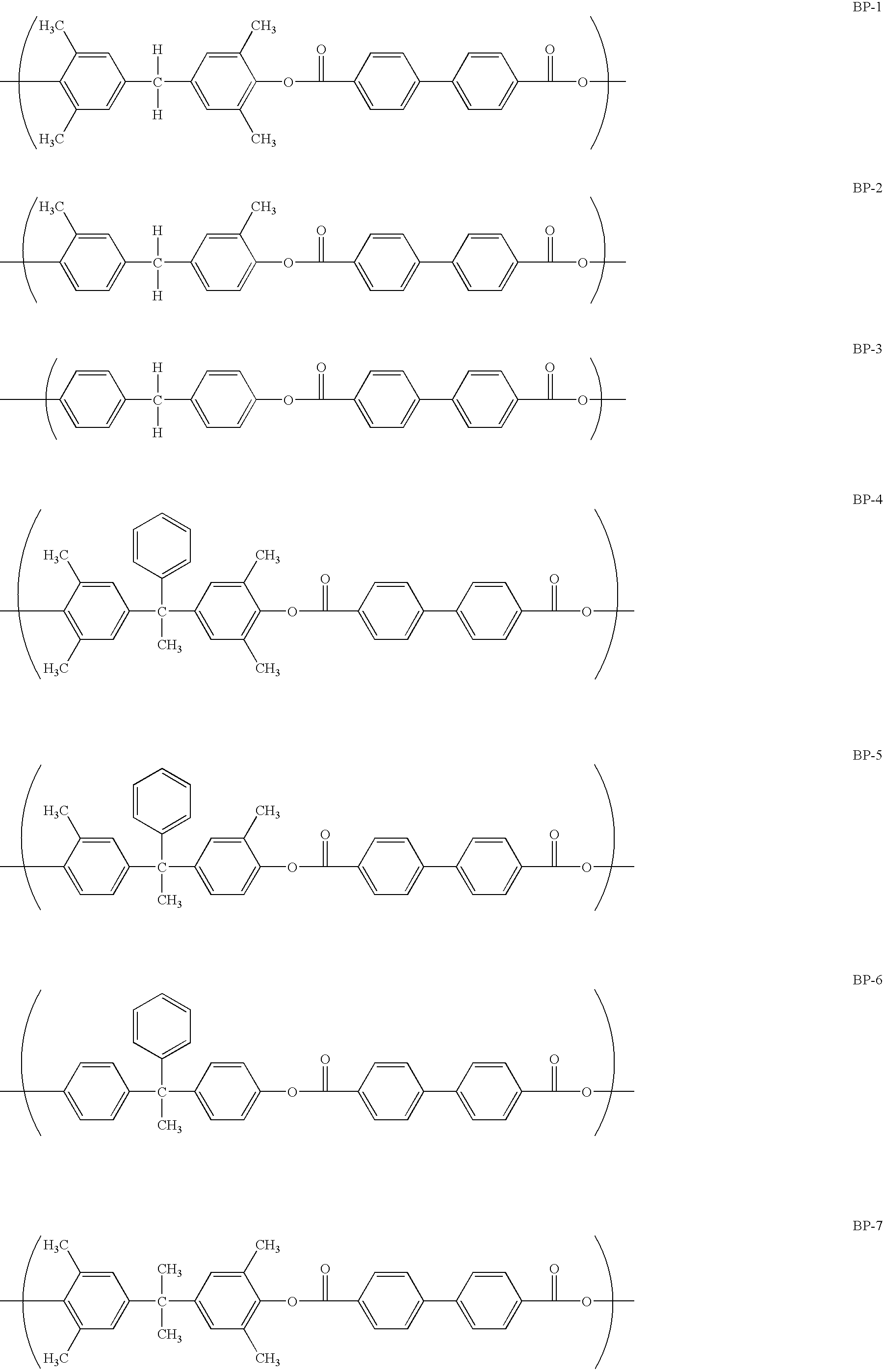

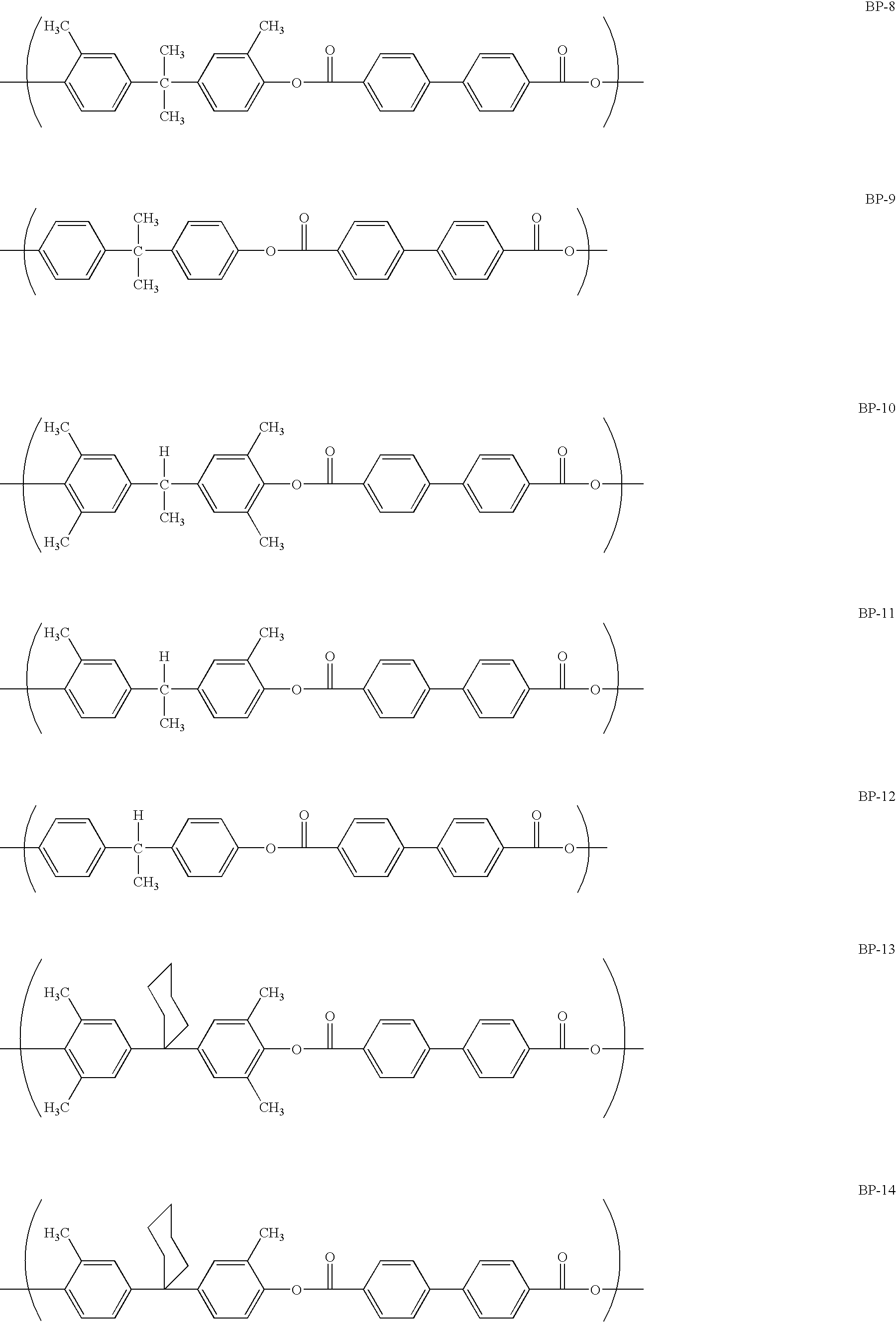

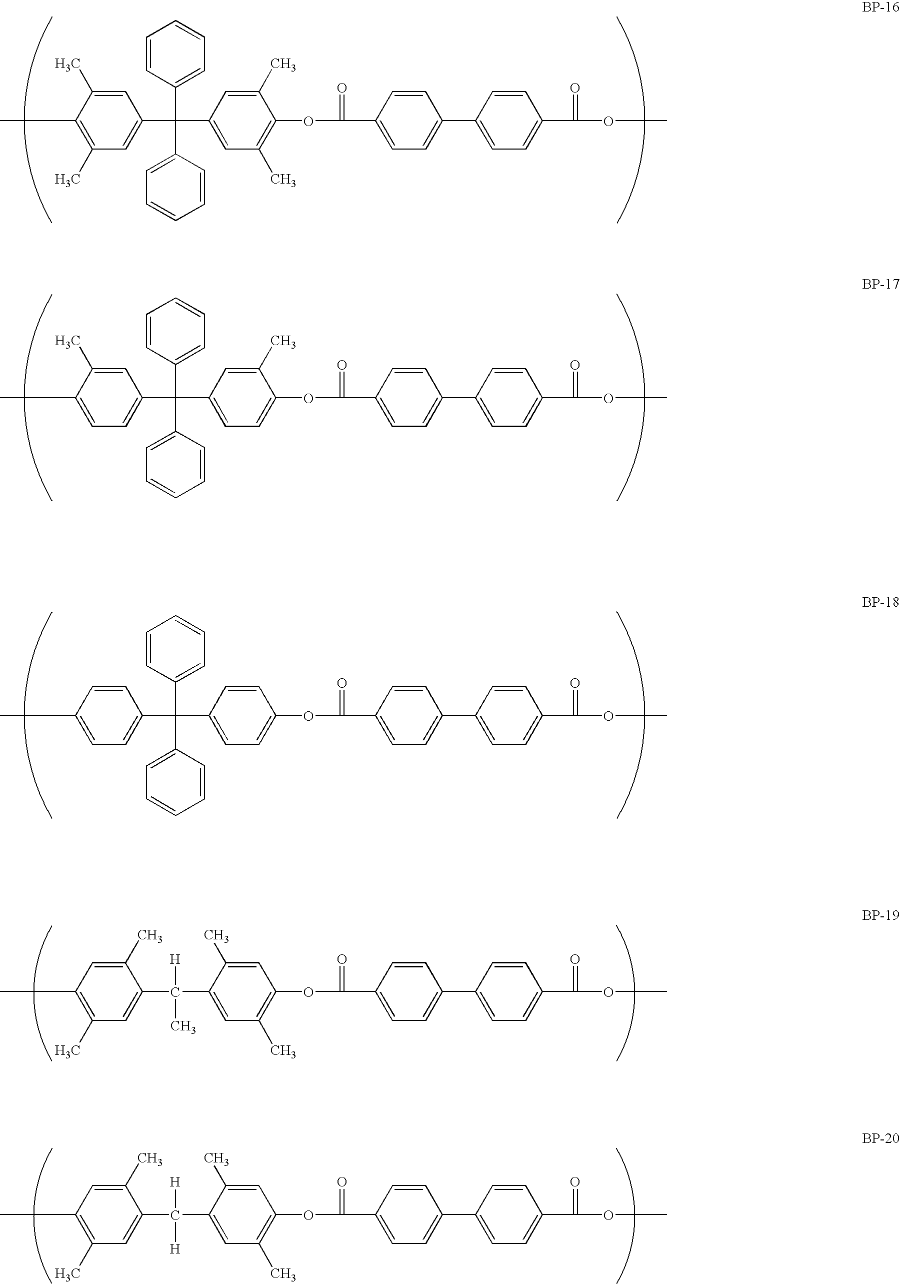

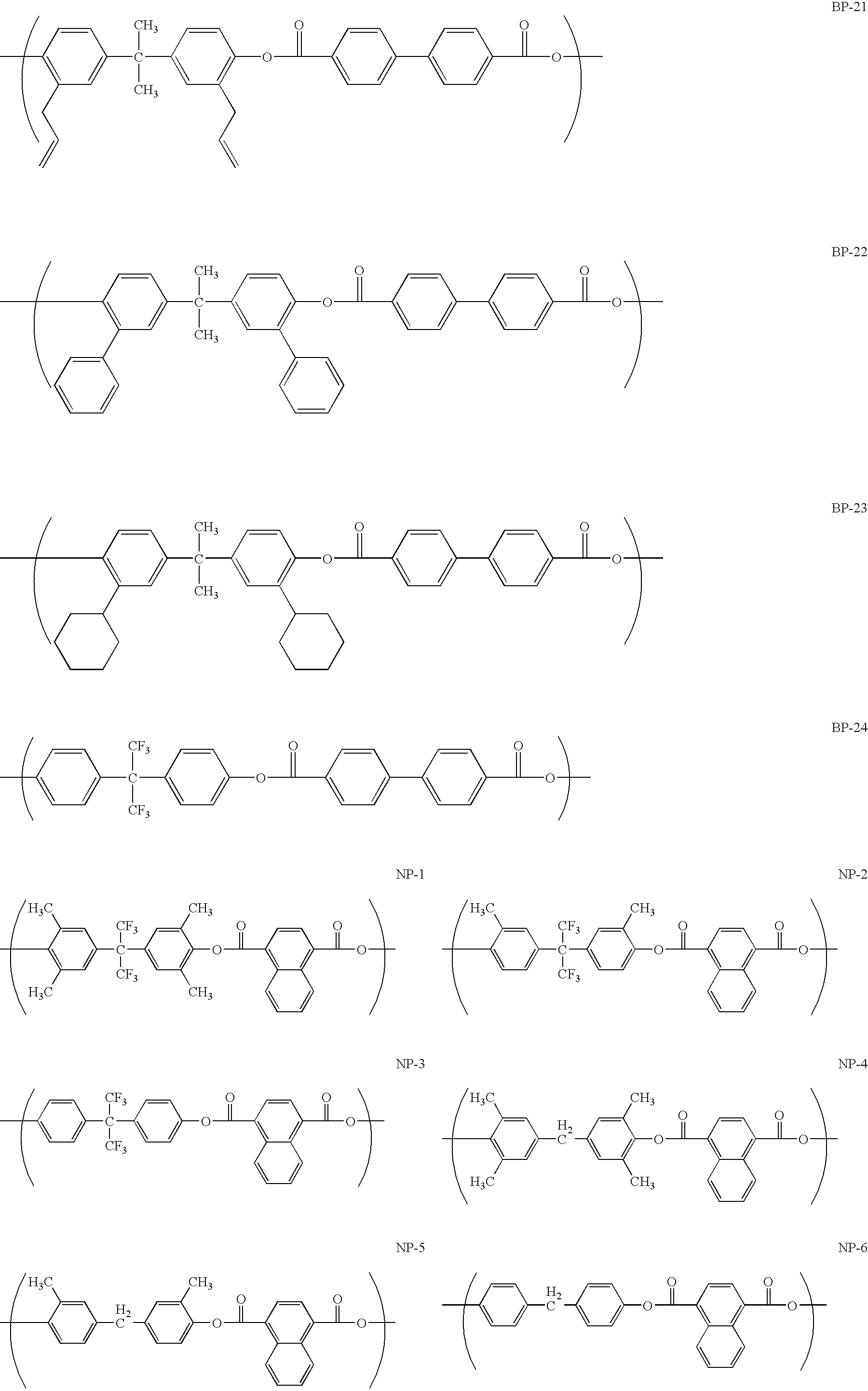

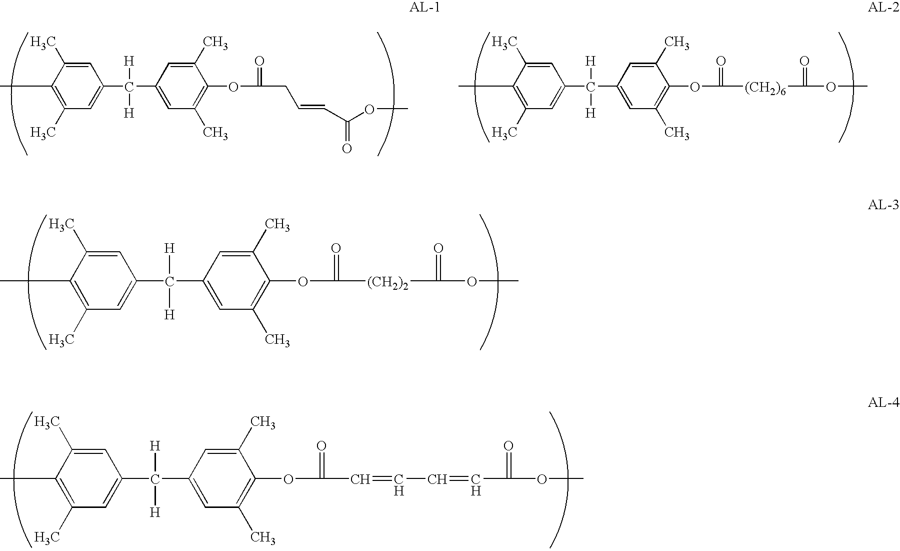

There are also exemplified resins A-G, described in JP-A 2007-41627 (paragraph 0075-0100).

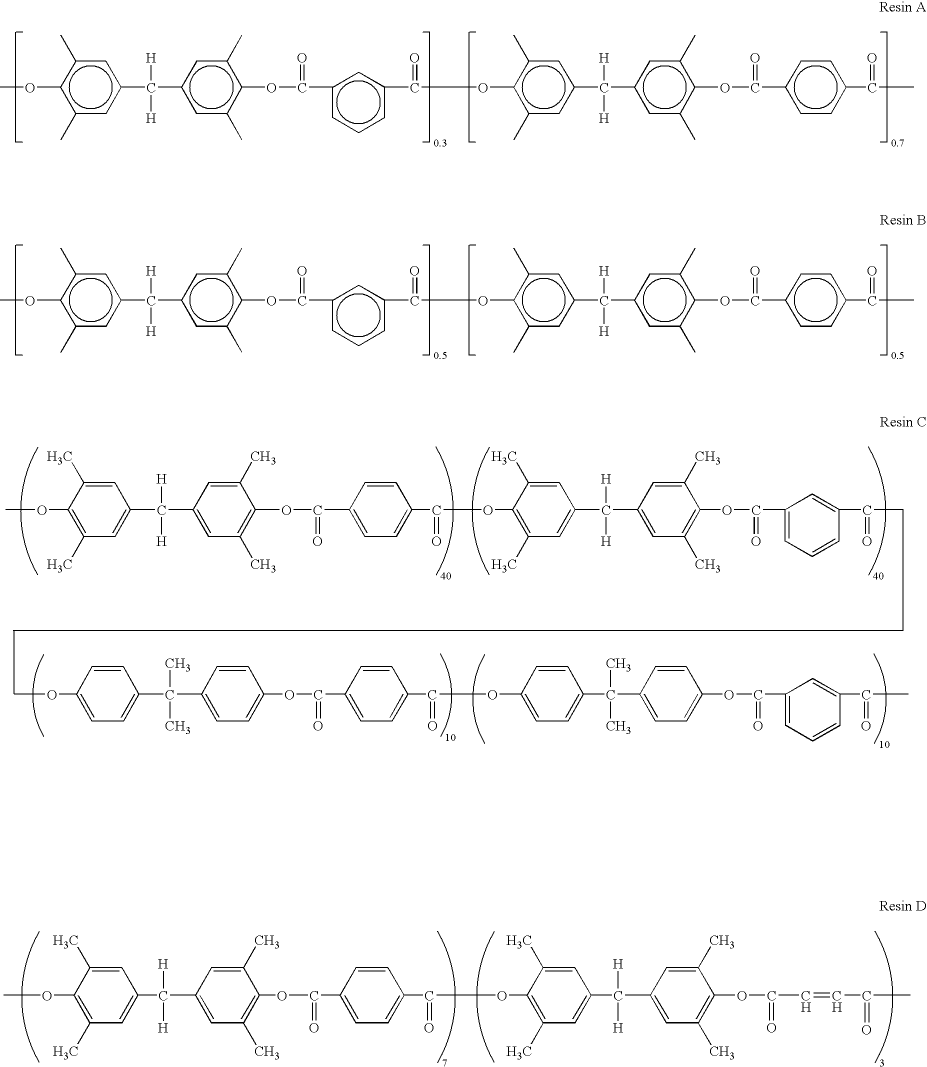

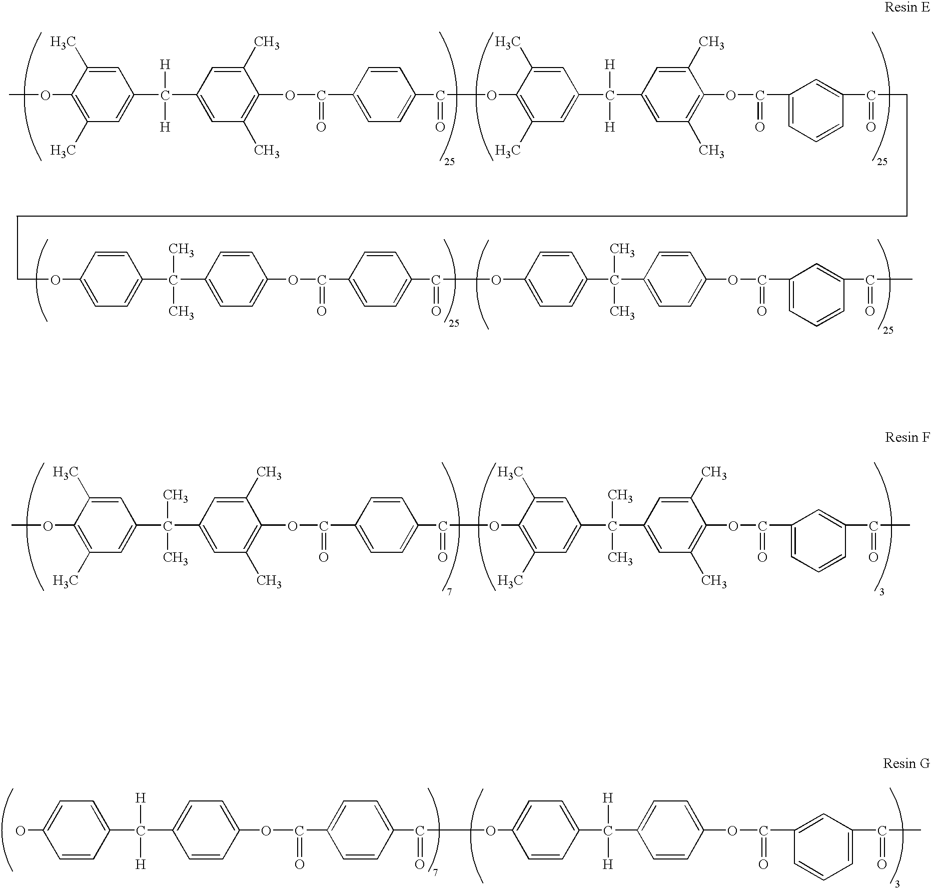

A polyarylate used in the invention is produced preferably by an interfacial polymerization method. In the production by an interfacial polymerization, there are mixed at least a bifunctional phenol component, a bisphenol component or a diol component, dissolved in an aqueous alkaline solution and at least an aromatic dicarboxylic acid chloride component, dissolved in a halogenated hydrocarbon solution.

In that case, a quaternary ammonium salt or a quaternary phosphonium salt may be present as a catalyst. Polymerization is conducted at a temperature of 0 to 40° C. over a period of 2 to 12 hrs., in terms of productivity. After completion of polymerization, an organic phase is separated from an aqueous phase and a polymer dissolved in the organic phase is washed and recovered according to the conventional method to obtain the targeted resin.

Examples of an alkaline component used therein include an alkali metal hydroxide such as sodium hydroxide or potassium hydroxide. Such an alkali is used preferably in an amount of 1.0 to 3 times a phenolic hydroxy group contained in the reaction system. Examples of a halogenated hydrocarbon include dichloromethane, chloroform, 1,2-dichloroethane, trichloroethane, tetrachloroethane and dichlorobenzene.

Examples of a quaternary ammonium salt or a quaternary phosphonium salt used as a catalyst include a salt hydrochloric acid, hydrobromic acid or hydroiodic acid of a tertiary alkylamine such as tributylamine or trioctylamine; benzyltriethylammonium chlorides benzytrimethylammonium chloride, benzyltributylammonium chloride, tetraethylammonium chloride, tetrabutylammonium chloride, tetrabutylammonium bromide, trioctylmethylammonium chloride, tetrabutylphosphonium bromide, triethyloctadecylphosphonium bromide, N-laurylpyridinium chloride and laurylpicolinium chloride.

After polymerization, purification of a resin is conducted in such a manner that a resin solution is washed with an alkaline solution of sodium hydroxide or potassium hydroxide, an acid solution of hydrochloric acid, nitric acid or phosphoric acid, or water and then subjected to stationary separation or centrifugal separation. Alternatively, purification may be conducted in such a manner that a solution of a formed resin is deposited in a solvent in which the resin is insoluble, a resin solution is dispersed in hot water to separate a solvent, or a resin solution is flown through an adsorption column.

After purification, a resin can be separated by depositing the resin in water, an alcohol or other solvents in which the resin is insoluble. Alternatively, a solution of a resin is dispersed in water or a dispersing medium in which the resin is insoluble and a solvent is distilled off, or a solvent may be distilled off by heating or under reduced pressure. A slurry resin is subjected to centrifugal separation or filtration to obtain a solid resin.

The thus obtained resin is dried at a temperature lower than a degradation temperature of conventional resin, and preferably at 20° C. or higher and a temperature lower than a melting point of the resin under reduced pressure. Drying is conducted over a period of time until the content of an impurity such a residual solvent reaches a prescribed level. Specifically, drying is conducted until the residual solvent content reaches usually not more than 1000 ppm, preferably not more than 300 ppm, and still more preferably not more than 100 ppm.

A polyarylate resin used in the invention usually exhibits a viscosity average molecular weight of not less than 10,000 and not more than 150,000, preferably not less than 15,000 and not more than 100,000, and still more preferably not less than 20,000 and not more than 50,000. A viscosity average molecular weight of less than 10,000 results in lowered mechanical strength of a resin is not suitable for practical use, and a viscosity average molecular weight of more than 150,000 renders it difficult to perform coating at an optimum thickness.

In the image forming method of performing development in a counter development system by use of a toner containing a polyarylate resin used in the invention, deposition, such as filming of microparticles on the photoreceptor surface is markedly reduced and clear images can be obtained over a long duration, not dependent on a usage environment. The reason thereof is not definite but it is assumed to be related with deformation behavior in response to stress of a polyarylate resin used in the invention.

A polyarylate resin used in the invention may be mixed with other resin to be used for an electrophotographic photoreceptor. Examples of such other resin include a vinyl polymer such as polymethyl methacrylate, polystyrene or polyvinyl chloride and its copolymer, a thermoplastic resin such as polycarbonate, polyester, polysulfone, phenoxy, epoxy and silicone resins and various thermosetting resins. Of these resins, a polycarbonate resin is preferred.

### Constitution Of Electrophotographic Photoreceptor

An electrophotographic photoreceptor used in the invention preferably is an organic photoreceptor. The surface layer of such an organic photoreceptor is formed a charge transport layer or a protective layer and contains an polyarylate resin represented by the formula (1)

In the invention, a photoreceptor refers to one which is constituted of an organic compound having at least one of a charge generation function and a charge transport function, and including all of commonly known photoreceptors, such as a photoreceptor constituted of a known charge generation material or charge transport material or a photoreceptor in which a charge generation function and a charge transport function are provided by polymeric complexes.

The layer arrangement of an organic photoreceptor is not specifically limited but an organic photoreceptor is constituted of a light-sensitive layer such as a charge generation layer, a charge transport layer or a charge generation/transport layer (which is a layer having charge-generating and charge-transporting functions in the same layer), and optionally a protective layer further thereon.

### Conductive Support

Electrically conductive support used in the invention may be in a sheet form or a cylindrical form but the cylindrical conductive support is preferred in design of a more compact image forming apparatus.

The cylindrical conductive support means a cylindrical support enable to endlessly achieve image formation through rotation. A cylindrical conductive support with a straightness of 0.1 mm or less and a deflection of 0.1 mm or less is preferred. A straightness and a deflection exceeding these ranges render it difficult to achieve superior image formation.

There are usable a metal drum such as aluminum or nickel as conductive material, a plastic drum on which aluminum, tin oxide or indium oxide is deposited and a conductive material-coated paper or plastic drum. There is preferred a conductive support exhibiting a specific resistance of not less 10³ Ω·cm at ordinary temperature.

A conductive support used in the invention may employ one having a sealed alumite surface layer. An alumite treatment is conducted usually in an acidic bath of chromic acid, sulfuric acid, oxalic acid, malic acid, boric acid, sulfamic acid or the like, but an anodic oxidation treatment in a sulfuric acid gives rise to most preferable results. The anodic oxidation treatment in a sulfuric acid is carried out preferably at a sulfuric acid concentration of 100 to 200 g/L, an aluminum ion concentration of 1 to 10 g/L, a liquid temperature of approximately 20° C. and an applied voltage of approximately 20 V, but is not limited to these. The average thickness of an anodic oxide coating is preferably not more than 20 μm and more preferably not more than 10 μm.

### Intermediate Layer

In the invention, it is preferred to provide an intermediate layer equipped with barrier function between the conductive support and the light-sensitive layer.

An intermediate layer (or sublayer) may be provided between the support and the foregoing light-sensitive layer to improve adhesion therebetween or to inhibit charge injection from the support. Examples of a material used for the intermediate layer include a polyamide resin, vinyl chloride resin, vinyl acetate resin and their copolymer resin containing at least two repeating units of the foregoing resins of these resins is preferred a polyamide resin, which minimizes an increase of residual electric potential along with repeating use. The thickness of an intermediate layer using such a resin is preferably from 0.01 to 0.5 μm.

The intermediate layer used in the invention is preferably cured by using a curable metal resin such as a silane coupling agent or a titanium coupling agent. An intermediated layer using such a curable metal resin is preferably 0.1-2 μm thick.

Intermediate layers used in the invention include an intermediate layer containing hydrophobilized titanium oxide particles (having an average particle size of 0.01-1 μm) dispersed in a binder such as a polyamide resin. The thickness of an intermediate layer is preferably from 1 to 15 μm.

### Light-Sensitive Layer

The light-sensitive layer of a photoreceptor used in the invention may be a single layer constitution which is comprised of a single layer having a charge generation function and a charge transport function in the layer, but is preferably separated in function to a charge generation layer (hereinafter, also denoted simply as CCL) and a charge transport layer (hereinafter, also denoted simply as CTL). Separation of function can control residual electric potential as low as possible during repeated use and can also easily control other electrophotographic characters in accordance with its object. A photoreceptor used for negative-charging is preferably constituted of a charge generation layer (CGL) on an intermediate layer and, further thereon, a charge transport layer (CTL). A photoreceptor used for positive-charging is in reverse of the layer constitution of the foregoing photoreceptor for negative-charging. In the invention, light-sensitive layer constitution preferably is one of the photoreceptor for negative-charging having a functional separation structure.

In the following, there will be described layer constitution of a function-separated negative-charging photoreceptor.

### Charge Generation Layer

A charge generation layer contains a charge generation material (hereinafter, also denoted simply as CGM). There may optionally be contained other materials such as a binder resin and additives.

There are usable commonly known charge generation materials as a charge generation material (CGM). Examples thereof include a phthalocyanine pigment, an azo pigment, a perylene pigment and azulenium pigment. Of these, a charge generation material (CGM) which minimizes an increase of residual electric potential along with repeated use is one which has a steric and electric potential structure capable of forming a stable aggregation between plural molecules. Such a CGM includes a phthalocyanine pigment and a perylene pigment. Examples thereof include a titanyl phthalocyanine exhibiting a maximum peat at a Bragg angle (2θ) of 27.2°; a hydroxygallium exhibiting characteristic diffraction peaks at Bragg angles (2θ) of 7.5°, 9.9°, 12.5°, 16.3°, 18.6°, 25.1° and 28.1°; a chlorogallium phthalocyanine exhibiting characteristic diffraction peaks at Bragg angles (2θ) of 7.4°, 16.6°, 25.5°, and 28.3°; a chlorogallium phthalocyanine exhibiting characteristic diffraction peaks at Bragg angles (2θ) of 6.8°, 12.8°, 15.8° and 26.6°; and a benzimidazole perylene exhibiting a maximum peak at a Bragg angle (2θ) of 12.4°. These CGM exhibit little deterioration after repeated use and can also minimize an increase of residual potential.

When the charge generation layer uses a binder as a dispersing medium for a CGM, commonly known binder resins are usable and examples of a preferred resin include a formal resin a butyral resin, a silicone resin, a silicone-modified butyral resin and a phenoxy resin. The ratio of a charge generation material to the binder is preferably 20 to 600 parts by mass to 100 parts by mass of the binder. The foregoing resins can minimize an increase of the residual potentials caused along with repeated use. The thickness of a charge generation layer is preferably from 0.1 to 2 μm.

### Charge Transport Layer

A charge transport layer contains a charge transport material (hereinafter, also denoted simply as CTM) and a binder resin to disperse the CTM to form a film layer. When a charge transport layer is the uppermost surface layer, its coating solution contains a polyarylate resin represented by the formula (1) as a binder resin and may further contain additives such as an antioxidant.

Commonly known charge transport materials are usable and examples thereof include triphenylamine derivatives, hydrazine compounds, styryl compounds, benzidine compounds and butadiene compounds. Such a charge transport material is dissolved in an appropriate binder to form a layer. Of these, a CTM capable of minimizing an increase of residual potential upon repeating its use is one which exhibits a high mobility and a difference of ionization potential from a combined CGM of not more than 0.5 eV and preferably not more than 0.25 eV.

The ionization potential of a CGM or a CTM can be measured by surface analyzer AC-1 (produced by Riken Keiki Co.).

When a charge transport layer is not an outermost surface layer, examples of a resin used in such a charge transport layer include a polyarylate resin represented by the formula (1), a polystyrene, an acryl resin, a methacryl resin, a vinyl chloride resin, a vinyl acetate resin, a polyvinyl butyral, an epoxy resin, a polyurethane, a phenol resin, a polyester, an alkyd resin, polycarbonate, a silicone resin, a melamine resin and copolymer resin having at least two repeating units of the foregoing resins. There is also included a polymeric organic semiconductor, such as poly-N-vinyl carbazole. Specifically, there is preferred a polycarbonate to maintain superior electrophotographic characteristics (for example, charging capability and sensitivity).

### Protective Layer

There may be provided a protective layer on the charge transport layer, in which a polyarylate resin represented by the formula (1) may be used as a binder resin. A charge transport material, an antioxidant or the like may be incorporated to the protective layer to maintain satisfactory electrophotographic characteristics (charging capability, sensitivity). Such an antioxidant used for the protective layer is typically a substance which is capable of prevent or inhibit an action of oxygen under light, heat or discharge for an auto-oxidizable material existing in the interior or on the surface of an organic photoreceptor. Typical examples of such a substance are shown below.

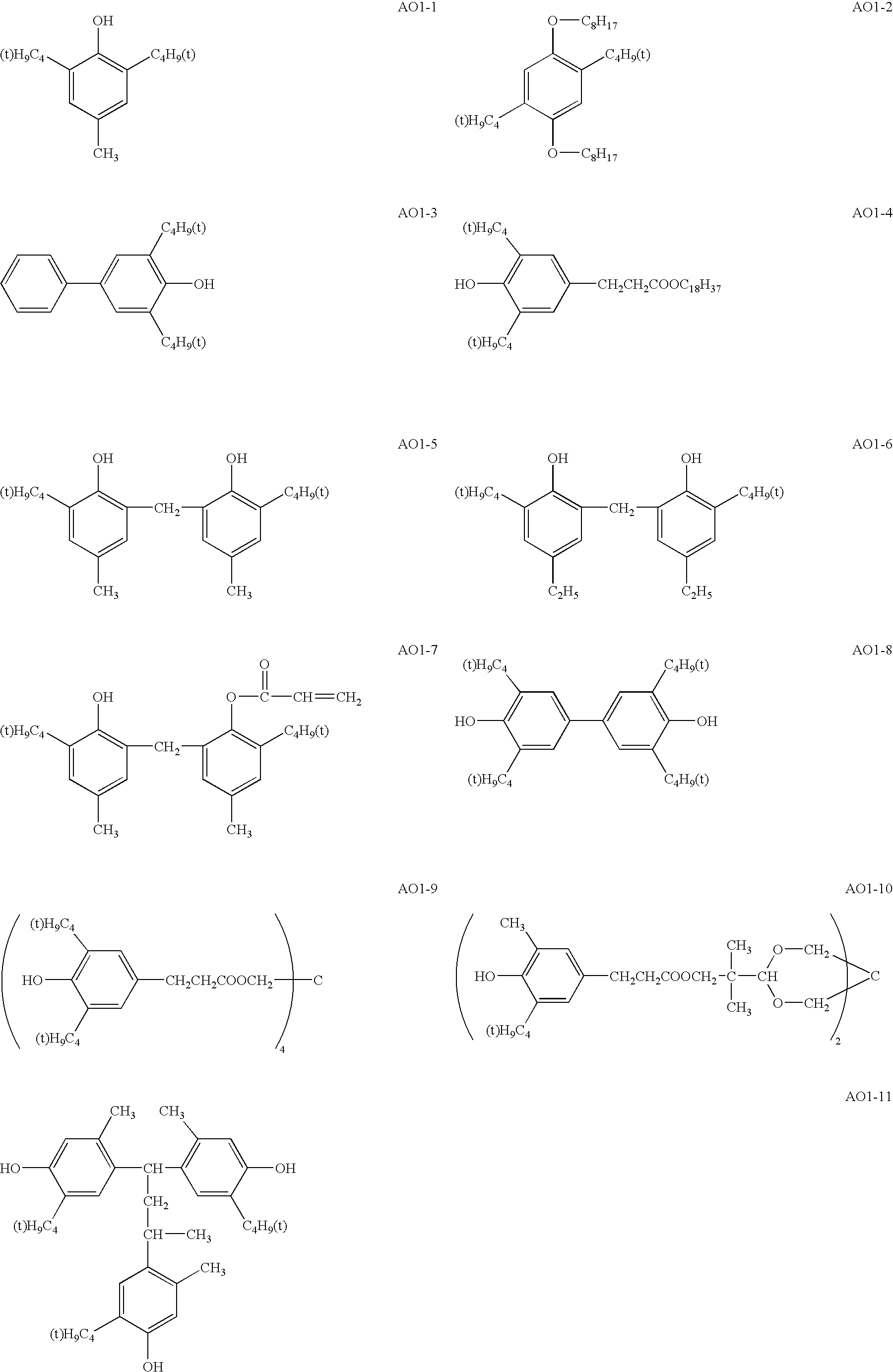

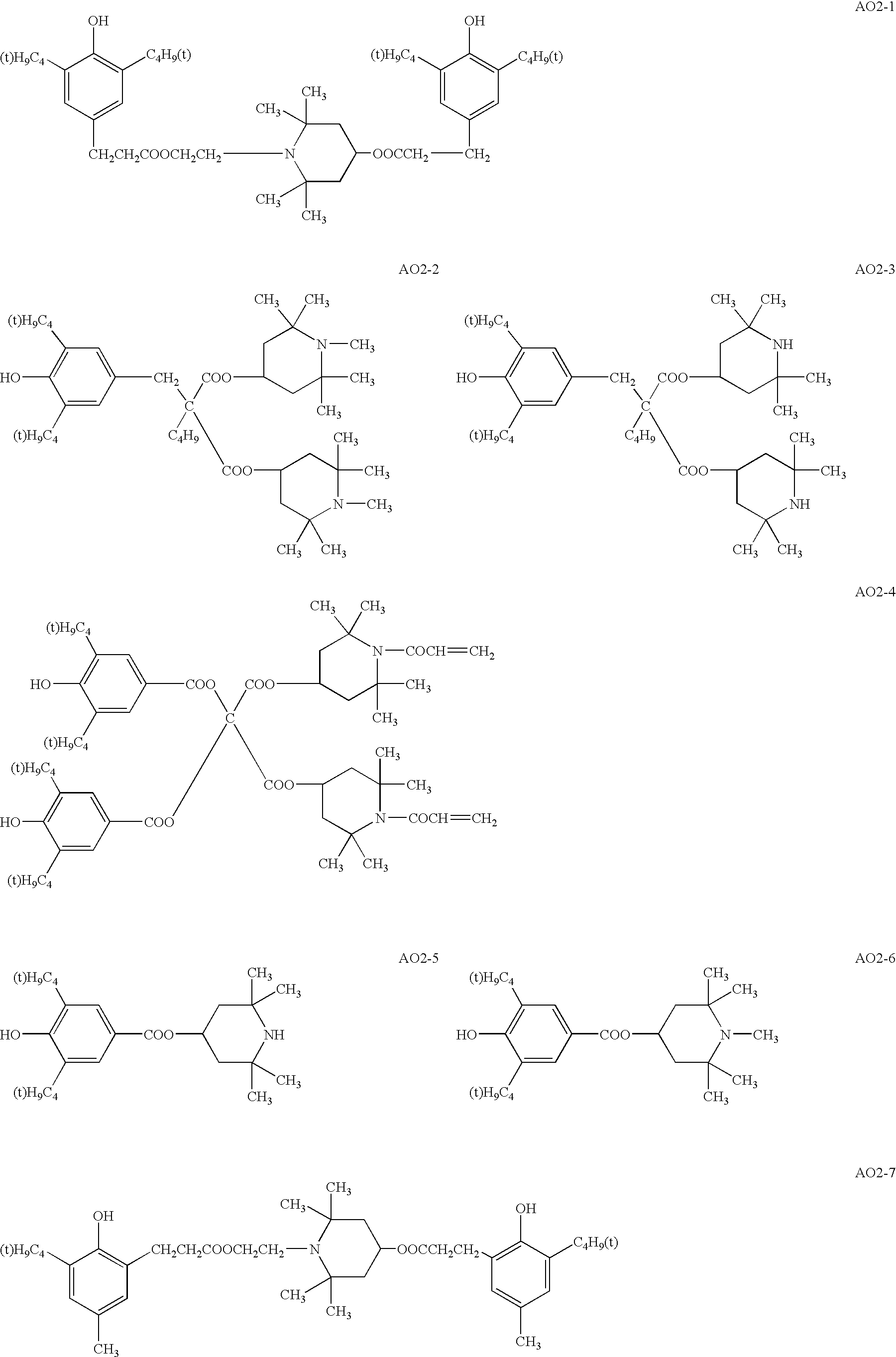

Solvents and dispersing media used for an intermediate layer, a light-sensitive layer or a charge transport layer include, for example, n-butylamine, diethylamine, ethylenediamine, isopropanolamine, triethanolamine, triethylene diamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethylsulfoxide and methyl cellosolve. The invention is not limited to these, but 1,2-dichloromethane, 1,2-dichloroethane and methyl ethyl ketone are preferred. These solvents may be used singly or in combination as mixed solvents.

Usable coating methods for production of electrophotographic photoreceptors relating to the invention include, for example, immersion coating, spray coating and circular amount control type coating, and to minimize dissolution of any lower layer when coating an upper light-sensitive layer, a spray coating or a circular amount-regulating type coating (typically, a circular slide hopper type coating) is preferred A protective layer is coated preferably by a circular amount-regulating type coating. The circular amount-regulating type coating is described in, for example, JP-A 58-189061.

### Toner

A toner used in the invention contains a resin and a colorant, and exhibiting a glass transition temperature (Tg) of from 16 to 44° C. The use of such a toner in the presence of a lubricant prevents deposition of microparticles, even when using an electrophotographic toner containing an arylate resin.

The toner used in the invention exhibits a softening point of from 75 to 120° C., preferably from 80 to 110° C.

A softening point falling within such a range can reduce text thickening or streak-like density unevenness and further achieve improvement of storage stability of the toner reduction of heat supply in fixing.

A softening of not less than 75° C. can inhibit expansion of the toner during fixing and a softening point of not more than 120° C. can achieve sufficient fixing, minimizing density unevenness.

The toner used in the invention preferably exhibits a glass transition temperature (Tg) of from 16 44° C., more preferably from 20 to 40° C. A Tg of not less than 16° C. results in neither toner filming nor aggregation of toner particles during storage, while a Tg of not more than 44° C. achieves fixing at a satisfactory level

The glass transition temperature of a toner used in the invention can be measured by using DSC-7 differential scanning calorimeter or TAC7/DX thermal analyzer controller (both produced by Perkin Elmer Corp.).

The measurement is conducted as follows. A toner of 4.5-5.0 mg is precisely weighed to two places of decimals, sealed into an aluminum pan (KIT NO. 0219-0041) and set into a DSC-7 sample holder. An empty aluminum pan is used as a reference. The temperature was controlled through heating-cooling-heating at a temperature-rising rate of 10° C./min and a temperature-lowering rate of 10° C./min in the range of 0 to 200° C. An extension line from the base-line prior to the initial rise of the first endothermic peak and a tangent line exhibiting the maximum slope between the initial rise and the peak are drawn and the intersection of both lines is defined as the glass transition point.

The softening point of a toner can be determined, for example, in the manner described below.

Under an environment of 20±1° C. and 50±5% RH, 1.10 g of a toner is placed into a petri dish, flattened, allowed to stand for 12 hrs and compressed under a pressure of 3×100 Mpa for 30 sec. by using a molding machine (SSP-10A, produced by Shimazu seisakusho Co., Ltd.) to form a disc-molded sample with 1 cm diameter.

Using a flow tester (CFT-500D, produced by Shimazu Seisakusho Co., Ltd.) and under an environment of 24±5° C. and 50±20% RH, the thus formed sample is extruded through a hole of a cylinder type die (1 mm×1 mm) by using a piston of 1 cm diameter after completion of pre-heating under conditions of a load of 180N, a start temperature of 40° C. pre-heating time of 300 sec. and a temperature increasing rate of 6° C./min. An off-set method temperature (T_{offset}) which is measured at an offset value of 5 mm in a melting temperature measurement by a temperature increasing method, is defined as the softening point of the toner.

The particles size of a toner relating to the invention is preferably from 3.0 to 8.0 μm. A toner image with a high density and enhanced sharpness can be obtained by toner particles falling within this range.

The particles size of a toner is represented in terms of a volume-based median diameter (D₅₀). The particle size of a toner can be measured using Coulter Multisizer (produced by Coulter Corp.). In the invention, using such Coulter Multisizer, an interface (produced by Nikaki Co. Ltd.) and a personal computer are connected thereto. The aperture used in the Coulter Multisizer is 100 μm and volume-based distribution of toner particles of 2 μm or more is measured to calculate the volume-based median diameter (D₅₀) of the toner particles.

### Production Of Toner

A toner exhibiting a softening point, as described above can be produced by methods such as a grinding process and a polymerization process.

The softening point of a toner can be controlled by selecting the kind of monomer constituting the resin used for resin particle formation or the monomer component ratio of a copolymer, by controlling the polymerization degree with controlling the amount of a chain transfer agent, or by adjusting the kind or amount of a fixing auxiliary agent to be added to the toner, such as a molding agent.

When forming toner particles by a process of polymerization, the toner particle size can be controlled by controlling the concentration of a coagulating agent, the addition amount of an organic solvent, the melting time, or the composition of a polymer. Formation of toner particles by a process of grinding is performed by controlling grinding conditions and classification conditions.

There will be further detailed production of a toner by a grinding process and production of a toner by a polymerization process.

### Toner Production By Grinding Process

Toner particles can be produced by a process of grinding (or grinding process). The grinding process comprises:

1. mixing a binder resin (binding resin) exhibiting a softening point, as described above, pigment particles and a molding agent under a non-pressurized condition,

2. melt-kneading the mixed binder resin and pigment particles to obtain a kneaded material,

3. grinding the obtained kneaded material to obtained a ground material, and

4. classifying the obtained ground material to obtain toner particles of the targeted particle size.

In the step of mixing and kneading raw materials is preferably used an extruder type kneading apparatus, in which a toner exhibiting the softening point described above can be obtained by controlling the kneading temperature within the range suitable for the toner. Controlling the kneading temperature can be achieved by controlling the temperature of the kneading zone of a kneading apparatus by using a heating medium or an electric heater. Since self-heating of a kneaded material is often caused during kneading, it is necessary to conduct temperature control with taking into account the binder resin structure and kneading torque.

Commonly known resins are usable as a binder resin but a resin exhibiting a glass transition temperature (Tg) of from 16 to 44° C. is preferred and one of a Tg of from 20 to 40° C. is more preferred. A Tg of less than 16° C. often causes adhesion of a toner resin onto the photoreceptor surface (that is, toner filming) and a Tg of more than 44° C. results in lowering in adhesion of toner particles and easily causes detachment of the toner, easily causing deposition of minute particles and leading to cleaning troubles due to increased abrasion.

Releasing agents usable in the invention include, for example, a low molecular weight polyethylene, a low molecular weight polypropylene, an amide wax and a polyhydric alcohol ester. A releasing agent is added preferably in an amount of from 1 to 10% by mass of a toner.

Examples of a colorant used for a black toner include pigments, such as carbon black (e.g., channel black, furnace black acetylene black, thermal black, lamp black) magnetic materials and titanium black; and dyes such as Nigrosine.

Examples of a colorant used for a yellow toner include dyes such as C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I Solvent Yellow 93, C.I. Solvent Yellow 98, C.I. Solvent Yellow 103, C.I. Solvent Yellow 104, C.I. Solvent Yellow 112, and C.I. Solvent Yellow 162; and pigments such as C.I. Pigment Yellow 14, C.I. Pigment Yellow 17, C.I. Pigment Yellow 93, C.I. Pigment Yellow 94, and C.I. Pigment Yellow 138.

Examples of a colorant used for a magenta toner include dyes such as C.I. Solvent Red 1, C.I. Solvent Red 49, C.I. Solvent Red 52, C.I. Solvent Red 58, C.I. Solvent Red 63, C.I. Solvent Red 11 and C.I. Solvent Red 122; and pigments such as C.I. Pigment Red 5, C.I. Pigment Red 48:1, C.I. Pigment Red 53:1, C.I. Pigment Red 57:1, C.I. Pigment Red 122, C.I. Pigment Red 139, C.I. Pigment Red 144, C.I. Pigment Red 149, C.I. Pigment Red 166, C.I. Pigment Red 178, C.I. Pigment Red 122, C.I. Pigment Orange 31 and C.I. Pigment Orange 43.

Examples of a colorant used for a cyan toner include dyes such as C.I. Solvent Blue 25, C.I. Solvent Blue 36, C.I. Solvent Blue 60, C.I. Solvent Blue 70, C.I. Solvent Blue 93 and C.I. Solvent Blue 95; and pigments such as C.I. Pigment Green 7, C.I. Pigment Blue 15:3 and C.I Pigment Blue 60.

There may be used a mixture of the foregoing colorants as a colorant used for a special color toner. The number average primary particle size of a dye or a pigment is variable but preferably within the range of from 10 to 200 nm.

There may optionally be added a charge controlling agent. A charge controlling agent is preferably colorless or white one when used for a color toner. Specific examples thereof include a zinc salt of salicylic acid or its derivative.

### Toner Production By Polymerization Process

Production of a toner by a polymerization process employs suspension polymerization and emulsion polymerization. The Tg of a resin of a toner obtained by a polymerization process is from 16 to 44° C. A Tg falling outside of the foregoing range, which results in defects described above, is not preferable.

Production of a toner by a polymerization process uses compounds such as a polymerizable monomer, a polymerization initiator and a colorant. There may optionally be used a releasing agent and a charge controlling agent.

Polymerizable monomers usable in the invention are not specifically limited, but preferred examples thereof include monovinyl monomers Specific examples of such a monovinyl monomer include a styrene monomer such as styrene, vinylstyrene, and α-methylstyrene; acrylic acid or methacrylic acid derivatives such as acrylic acid, methacrylic acid, methyl acrylate, ethyl acrylate, propyl acrylate, butyl acrylate, 2-ethylhexyl acrylate, cyclohexyl acrylate, dimethylaminoethyl acrylate, methyl methacrylate, propyl methacrylate, butyl methacrylate, 2-ethylhexyl methacrylate, dimethylaminoethyl methacrylate, acrylamide, and methacrylamide; monoolefin monomer such as ethylene propylene and butylene; a vinyl ester such as vinyl acetate and vinyl propionate; a vinyl ether such as vinyl methyl ether and vinyl ethyl ether; a vinyl ketone such as vinyl methyl ketone and methyl isopropenyl ketone; and a nitrogen-containing vinyl compound such as 2-vinylpyridine, 4-vinylpyridine and 4-vinylpyrrolidone. These monovinyl monomers may be used singly or in combination of plural monomers. Of these monomers are preferred a styrene monomer, or combination of a styrene monomer and an acrylic acid or methacrylic acid derivative.

The use of a curable monomer or polymer in combination with a polymerizable monomer is effective for improvement of hot offset. Such a curable monomer is a monomer having at least two polymerizable, carbon-carbon unsaturated double bond. Specific examples thereof include an aromatic divinyl compound such as divinylbenzene, divinylnaphthalene and their derivatives; a diethylenically unsaturated carboxylic acid ester such as ethyelene glycol dimethacrylate and diethylene glycol dimethacrylate; a compound containing two vinyl groups such as N,N-divinylaniline and divinyl ether; and a compound containing three vinyl groups such as pentaerythritol allyl ether and trimethylolpropane triacrylate. A curable polymer is a polymer containing at least two vinyl groups in the polymer and specific examples thereof include polyethylene, polypropylene, polyester and, each of which contains at least two hydroxy groups in the molecule, and an easter of polyethylene glycol and acrylic or methacrylic acid. Such curable monomers or curable polymers are each usable singly or in combination, usually in an amount of not more than 10 parts by mass of 100 parts by mass of a polymerizable monomer, preferably from 0.1 to 2 parts by mass.

The use of a macromonomer as a polymerizable monomer is preferred to improve balance between storage stability and fixability at low temperature. Such a macromonomer contains a polymerizable vinyl group at the end of the molecular chain, which is usually an oligomer or a polymer having a number average molecular weight of 1,000 to 30,000. The use of an excessively low molecular weight results in softening of the polymer particle surface, leading to deteriorated storage stability, while the use of an excessively high molecular weight results in deteriorated fusibility of a macromonomer, leading to lowered fixability and reduced storage stability. Examples of a polymerizable vinyl group at the molecular chain end include an acryloyl group and a methacryloyl group, in which a methacryloyl group is preferred in terms of co-polymerizability.

A macromonomer preferably is one which exhibits a glass transition temperature higher than that of a polymer obtained by polymerization of a monovinyl type monomer, as described above. The glass transition temperature of a macromonomer is relative to that of a polymer obtained by polymerization of a monovinyl monomer. For instance, when a monovinyl monomer forms a polymer exhibiting a Tg of 44° C., a macromonomer may be one which exhibits a Tg higher than 44° C. When a monovinyl monomer forms a polymer exhibiting a Tg of 16° C., the macromonomer may be one which exhibits a Tg of, for example, 50° C. The Tg of a macromonomer can be determined by using a measurement instrument, such as a differential scanning calorimeter (DSC).

Specific examples of a macromonomer include a polymer obtained by polymerizing styrene, styrene derivatives, a methacrylic acid ester, an acrylic acid ester, acrylonitrile, or methacrylonitrile singly or in combination, a macromonomer having a polysiloxane skelton and macromonomers disclosed in JP-A 3-203746 on page 4-7. A polymer obtained by polymerization of a hydrophilic macromonomer, specifically, a methacrylic acid ester or acrylic acid ester singly or in combination, is suitable in the invention. Such a macromonomer is used usually in an amount of 0.01 to 10 parts by mass, preferably from 0.03 to 5 parts by mass, more preferably from 0.053 to 1 parts by mass. A small amount of a macromonomer results in no improvement of storage stability and an excessive amount of a macromonomer results in lowered fixability.

Examples of a polymerization initiator include persulfates such as potassium persulfate and ammonium persulfate; azo compounds such as 4,4′-azobis(4-cyanovaleric acid), 2,2′-azobis(2-amidinopropane) di-(hydrochloric acid), 2,2′-azobis-2-methyl-N-1,1′-bis(hydroxymethyl)-2-hydroxyethylpropioamide, 2,2′-azobis(2,4-dimethylvalerilonitrile), 2,2′-azobisisobutyronitrile, 1,1′-azobis(1-cyclohexanecarbonitrile); peroxides such as di-t-butylperoxide, acetyl peroxide, dicumyl peroxide, lauroyl peroxide, benzoyl peroxide, t-butyl peroxy-2-ethylhexanoate, t-butylperbutylneodecate, t-butylperbtylneodecanoate, t-hexylperoxy-2-ethylhaxanoate, t-butylperoxypivalate, t-hexylperoxypivalate, di-isopropylperoxydicarbonate, di-t-butylperoxyisophthalate, 1,1′,3,3′-tetramethylbutylperoxy-2-ethylhexanoate and t-butylperoxyisobutyrate. There are also cited redox initiators obtained by combination of the foregoing polymerization initiators with reducing agents. It is preferred to choose, from these initiators, an oil-soluble polymerization initiator soluble in an polymerizable monomer to be used, in which a water-soluble initiator may optionally be used in combination. The foregoing polymerization is used usually in an amount of from 0.1 to 100 parts by mass of 100 parts by mass of a polymerizable monomer, preferably from 0.3 to 15 parts by mass, and more preferably from 0.5 to 10 parts by mass. A polymerization initiator is added, preferably in advance, to the polymerizable monomer composition, but may be added to a suspension after completion of the process of particle formation.

There are usable, as a colorant, any pigment and/or dye such as carbon black, titanium white and the like. A carbon black preferably has a primary particle size of from 20 to 40 nm. A particle size of less than 20 nm cannot achieve sufficient dispersion of carbon black, resulting in a toner which easily causes fogging. A particle size of more than 40 nm results in an increased amount of a polycyclic-aromatic hydrocarbon compounds, producing problems in safety.

There are usually used a yellow colorant, a magenta colorant and a cyan colorant to obtain a full-color toner. Azo pigments and condensed polycyclic pigments are used as a yellow colorant. Specific examples of such a yellow pigment include C.I. Pigment Yellows 3, 12, 13, 14, 15, 17, 62, 65, 73, 83, 90, 93, 97, 120, 138, 155, 180 and 181. Azo pigments and condensed polycyclic pigments are used as a magenta colorant. Specific examples of such a magenta pigment include C.I. Pigment Reds 48, 57, 58, 60, 63, 64, 68, 81, 83, 87, 88, 89, 90, 112, 114, 122, 123, 144, 146, 149, 163, 170, 184, 185, 187, 202, 206, 207, 209, 251, and C.I. Pigment Violet 19. As a cyan colorant are used copper phthalocyanine compounds and their derivatives, and anthraquinone compounds. Specific examples thereof include C.I. Pigment Blues 2, 3, 6, 15, 15:1, 15:2, 15:3, 15:4, 16, 17 and 60.

Compounds exhibiting a low softening point are used as a releasing agent. Specific examples thereof include a low molecular weight polyolefin waxes such as a low molecular weight polyethylene, low molecular weight polypropylene and low molecular weight polybutylene, and end-modified polyolefin waxes such as a molecular end-oxidized and low molecular weight polypropylene, a molecular end-modified and low molecular weight polypropylene which is substituted by an epoxy group at the molecular end and block copolymers of these polymers and a low molecular weight polyethylene; natural plant waxes such as candelilla wax, carnauba wax, rice wax, haze wax, hohoba wax; petroleum wax and its modified wax such as paraffin, microcrystalline, petrolatum; mineral wax such as montan wax, ceresine wax and ozocerite; synthetic wax such as Fischer-Tropsch wax; pentaerythritol esters such as pentaerythritol tetramyristate, pentaerythritol tetrapalmitate, and pentaerythritol tetralaurate; dipentaerythritol ester such as dipentaerythritol hexamyristate, dipentaerythritol hexapalmitate, and dipentaerythritol haxalaurate. These may be used singly or in combination.

Of these are preferred a synthetic wax (Fischer-Tropsch wax), a synthetic polyolefin, low molecular weight polypropylene wax, and microcrystalline wax. Specifically, a pentaerythritol ester in which in the DSC curve measured by a differential scanning calorimeter, an endothermic peak temperature at the time of temperature increasing falls within the range of 30 to 200° C. (preferably from 50 to 180° C., and more preferably from 60 to 160° C.), and a polyvalent ester compound such as dipentaerythritol ester in which such an endothermic peak temperature falls with the range of 50 to 80° C. are preferred in terms of balance between fixability and releasability. Specifically, a pentaerythritol ester which has a molecular weight of 1000 or more, is soluble in styrene in an amount of at least 5 parts by mass per 100 parts by mass of styrene at 25° C. and exhibits an acid value of not more than 10 mg/KOH, is markedly effective when the fixing temperature is lowered. The endothermic peak temperature of a toner can be determined in accordance with ASTM D3418-82. A compound exhibiting a low softening point, as described above, is used preferably in an amount of 0.1 to 20 parts by mass (more preferably from 1 to 15 parts by mass) per 100 parts by mass of a polymerizable monomer.

A charge control agent is preferably incorporated into the polymerizable monomer composition to enhance charging capability of a toner, and there are usable positive- or negative-charge control agents. Specific examples thereof include BONTRON N01 (produced by Orient Chemical Co.), Nigrosin Base EX (produced by Orient Chemical Co.), Spiro Black TRH (produced by Hodogaya Chemical Co.), T-77 (produced by Hodogaya Chemical Co.), BONTRON S-34 (produced by Orient Chemical Co.), BONTRON E-81 (produced by Orient Chemical Co.), BONTRON E-84 (produced by Orient Chemical Co.), BONTRON E-89 (produced by Orient Chemical Co.), BONTRON F-21 (produced by Orient Chemical Co.), COPY CHRGE NX (Clarient International Ltd., Co.), COPY CHRGE NEG (Clarient International Ltd., Co.), TNS-4-1 (produced by Hodogaya Chemical Co.), TNS-4-l (produced by Hodogaya Chemical Co.), TNS-4-2 (produced by Hodogaya Chemical Co.), and LR-147 (produced by Nippon Carlite Co.); quaternary ammonium (salt) group-containing copolymers described in JP-A 11-15192, 3-175456 and 3-243954; and sulfonic acid (salt) group-containing copolymers described in JP-A 3-243954, 1-217464, and 3-15858. Such a charge control resin is preferred in terms of achieving toner images with stable charging capability even when continuously printed at a high-speed. A charge control agent is used usually in an amount of 0.01 to 10 parts by mass, preferably from 0.1 to 7 parts by mass per 100 parts by mass of polymerizable monomer.

Production of toner particles by suspension polymerization or emulsion polymerization can use a dispersion stabilizer to stabilize the produced particles.

Specific example of such a dispersion stabilizer include sulfates such as barium sulfate and calcium sulfate; carbonates such as barium carbonate, calcium carbonate and magnesium carbonate; phosphates such as calcium phosphate; metal oxides such as aluminum oxide and titanium oxide; metal hydroxides such as aluminum hydroxide, magnesium hydroxide and ferric hydroxide; water-soluble polymers such as polyvinyl alcohol, methyl cellulose and gelatin; anionic surfactant, cationic surfactants and amphoteric surfactants. Of these, a dispersion stabilizer which contains a metal compound, specifically, a hardly water-soluble, colloidal metal hydroxide, can control the particle size distribution of polymer particles and is suitable for enhancement of image sharpness.

Such a dispersion stabilizer containing a hardly water-soluble metal hydroxide colloid is not specifically limited in its production method but it is preferred to use a hardly water-soluble metal hydroxide colloid obtained by adjusting the aqueous solution of a water-soluble polyvalent metal compound to a pH of not more than 7, specifically, a hardly water-soluble metal hydroxide colloid obtained by reaction of a water-soluble polyvalent metal compound and an alkali metal hydroxide in an aqueous phase.

Such a hardly water-soluble metal hydroxide colloid preferably exhibits a number-based particle size distribution of D50 (which is 50% cumulative value of number-based particle size distribution) of not more than 0.5 μm and D90 (which is a 90% cumulative value of number-based particle size distribution) of not more than 0.5 μm. A larger colloidal particle size results in lowering of polymerization stability as well as reduced storage stability of a toner.

A dispersion stabilizer is used usually in an amount of 0.1 to 20 parts by mass per 100 parts by mass of a polymerizable monomer, and preferably from 0.3 to 10 parts by mass. A smaller amount makes it difficult to achieve sufficient polymerization stability and dispersion stability, easily resulting in formation of coagulates. A larger amount tends to result in broader particle size distribution due to the increased number of fine particles.

The polymerizable monomer composition can be obtained by homogeneously mixing the foregoing colorant, polymerizable monomer, a polymerization initiator and the like. The method for homogeneous-mixing is not specifically limited but a media type dispersing machine such as a ball mill is usable. A mixing method to obtain a polymerizable monomer composition is not specifically limited but is preferably conducted in the manner described below. Although a polymerization initiator may be mixed with a polymerizable monomer together with a colorant and the like before being dispersed in an aqueous medium, there is a concern that the polymerization initiator generates radicals due to heat generated during dispersion and the polymerizable monomer is unexpectedly polymerized, inducing scattering in a toner characteristic. Therefore, additives such as a colorant and a charge control agent are added to a polymerizable monomer and is further added to an aqueous medium. After the composition becomes coarse dispersed droplets, a polymerization initiator is added thereto to allow the composition to absorb the polymerization initiator and the dispersion is dispersed by using a dispersing machine to form dispersed droplets.

Such a dispersing machine preferably is a high-speed rotary-shearing mixer constituted of a high-speed rotating turbine of a special form and a stator having a radial baffle, in which the solution to be treated is sucked through a suction hole in the stator by employing performance of an ejection action by the difference in pressure between bottom and upper portions of the turbine, produced by high-speed rotation of the turbine and is ejected from an ejection hole of the stator by the action of shearing, impact, cavitation or the like. Specific examples of such a high-speed rotary-shearing mixer include CLEARMIX (produced by M TECHNIQUE Co.) and EBARA MILDER (produced by Ebara Seisakusho Co.). In this dispersion stage, the polymerizable monomer composition is brought into contact with the dropwise-added polymerization initiator and is introduced into droplets to form droplets of the polymerizable monomer composition.

The timing of adding the polymerization initiator to an aqueous dispersion medium is preferably after addition of the polymerizable monomer composition and in the course of formation of droplets of the polymerizable monomer composition. Addition of a polymerization initiator after formation of fine droplets of the polymerizable monomer composition in an aqueous medium renders it difficult to uniformly introduce the polymerization initiator into the droplets. The timing of adding a polymerization initiator, depending of the objective toner particles, is at the time when after addition of the polymerizable monomer composition, the particle size (volume average particle size) of primary droplets formed by stirring reaches usually 50-1000 μm, and preferably 100-500 μm. When the period of time from addition of the polymerizable monomer composition to addition of a polymerization initiator is too long, droplet formation is completed and the polymerizable monomer composition cannot be homogeneously mixed with the polymerization initiator, rendering it difficult to make resin characteristics such as polymerization degree and cross-linkage degree uniform in toner particles. Accordingly, the time of adding a polymerization initiator, depending to a certain degree on the reaction scale or particle size, is generally after addition of the polymerizable monomer composition, usually within 24 hrs, preferably within 12 hrs. (more preferably, 3 hrs.), and is usually within 5 hrs and preferably within 3 hrs. (more preferably, 1 hr.) at the small scale of the experiment room scale.

The temperature of an aqueous medium from addition of a polymerization initiator to the subsequent droplet formation (i.e., before initiating polymerization) is usually within the range of from 10 to. 40° C., and preferably from 20 to 30° C. An excessively high temperature initiates polymerization partially in the system, whereas an excessively low temperature lowers fluidity of the system, causing troubles in droplet formation. After bringing droplets of the polymerizable monomer composition into contact with droplets of a polymerization initiator to form droplets of the monomer composition containing the initiator, stirring is continued to form secondary droplets of the intended size, followed by suspension polymerization. The secondary droplet size, depending on the subsequent suspension polymerization, is usually from 1 to 50 μm, preferably from 3 to 30 μm, and more preferably from 5 to 30 μm. The time to form droplets can be arbitrarily controlled, depending on the kind and amount of polymerizable monomer, additive and polymerization initiator, the droplet formation temperature, the kind of droplet-forming machine and intended droplet size. The aqueous dispersion used in the invention is a dispersion of the foregoing composition dispersed in an aqueous medium. Such an aqueous medium may be water alone but suitably water containing a dispersing agent.

The volume average droplet size of the polymerizable monomer composition in a dispersion is usually from 2.0 to 10.0 μm, preferably from 2.0 to 9.0 μm, and more preferably from 3.0 to 8.0 μm. An excessively large size makes droplets unstable during polymerization, resulting in large toner particles and leading to lowering in image resolution. The ratio of volume average particle size/number average particle size of droplets is usually from 1 to 3, and preferably from 1 to 2. A broad distribution of droplet size gives rise to scatter in fixing temperature, causing troubles such as fogging, streak defect and filming. It is suitable that at least 30% by volume (preferably at least 60% by volume) falls with the range of volume average particle size ±1 μm.

### Production Of Toner

In the invention, the thus produced toner particles may be used as such for a toner but are preferably mixed with an external additive. There are cited, as external additives, inorganic particles and organic resin particles. Examples of inorganic particles include silicon dioxide, aluminum oxide, titanium oxide, zinc oxide, tin oxide, barium titanate, and strontium titanate. Examples of organic resin particles include particulate methacrylic acid ester polymer, particulate acrylic acid ester polymer, particulate styrene-methacrylic acid ester copolymer, particulate styrene-acrylic acid ester copolymer, zinc stearate, calcium stearate, and core/shell particles formed of a core of a styrene polymer and a shell of a methacrylic acid ester copolymer. Of these, silicon dioxide is suitable as inorganic oxide particles. The particle surface may be subjected to a hydrophobilization treatment and hydrophobilized silicon dioxide particles are specifically preferred. The amount of an external additive is usually from 0.1 to 6 parts by mass of 100 parts by mass of toner particles.

At least two external additives may be combined, in which a combination of at least two inorganic particles differing in particle size, or a combination of inorganic particles and organic resin particles is preferred. Adhesion of an external additive is performed by mixing an external additive and toner particles in a mixer such as Henschel mixer (produced by Mitsui-Miike Kako Co., Ltd.).

### Developer

A developer used in the development stage may be a single component developer or a two-component developer.

Single component developers include a nonmagnetic single component developer and a magnetic single component developer in which magnetic particles of 0.1 to 0.5 μm are contained in toner particles.

A two-component developer is prepared by mixing 3 to 20 parts by mass of a toner with 100 parts by mass of a carrier. Magnetic particles as a carrier can use conventionally used materials, for example, metals such as iron ferrite and magnetite and alloys of the foregoing metals and a metal such as aluminum or lead. Of these, ferrite particles are preferred. The foregoing magnetic particles preferably have a volume average particle size of from 1 to 100 μm, and more preferably from 25 to 80 μm.

The volume average particle size of a carrier can be determined typically using a laser diffraction type particle size distribution measurement apparatus, provided with a wet dispersing machine, HELOS (produced by SYMPATEC Corp.).

A carrier preferably is one in which a magnetic particle is covered with a resin and one in which magnetic particles are dispersed in a resin, so-called a resin dispersion type carrier. The resin composition used for coating is not specifically limited and examples of resin usable in the invention include an olefin resin, styrene resin, styrene-acryl resin, silicone resin, ester resin and a fluororesin. Examples of a resin constituting a resin dispersion type carrier include a styrene-acryl resin, polyester resin, fluororesin and phenol resin.

There will be described an image forming apparatus relating to the invention. In an image forming apparatus relating to the invention, a cylindrical developing sleeve carrying a developer is brought into contact with the photoreceptor with rotating the developing sleeve in the counter direction to the rotation of the photoreceptor to develop an electrostatic image to form a toner image.

### Image Forming Apparatus

In an image forming apparatus relating to the invention, there are disposed plural image forming units comprising a developing means in which an electrostatic latent image is formed on an organic photoreceptor, a developing brush is formed of a developer containing a toner image on a cylindrical developing sleeve and the developing brush is brought into contact with the organic photoreceptor to develop the electrostatic latent image to form a toner, and a transfer means to transfer the toner image formed on the organic photoreceptor to a transfer medium. Using toners differing in color for the plural image forming units, different color toner images are formed on the organic photoreceptor and transferred from the organic photoreceptor to the transfer medium to form a color image. The image forming apparatus further comprises a means for supplying a lubricant onto the surface of the organic photoreceptor and develops an electrostatic latent image to form a toner image, while rotating the developing sleeve in the counter direction to the rotation of the photoreceptor.

The image forming apparatus having the foregoing constitution can prevent fogging or density trouble on the top portion which is easily caused in a counter development system, providing a high quality digital image or color image.

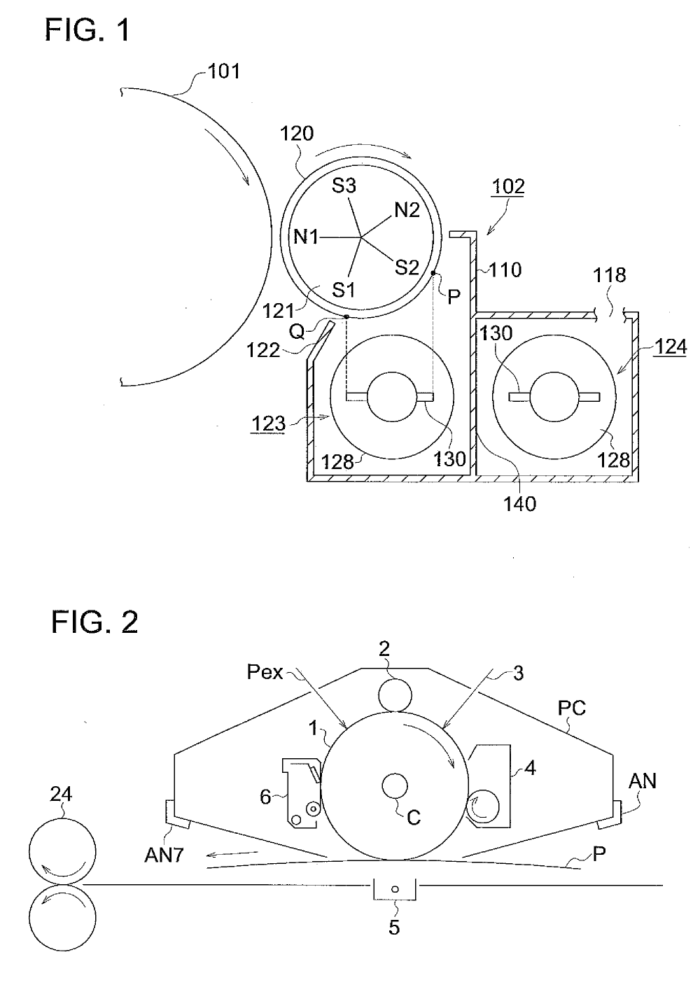

A developing device (developing means) of a counter development system will be described with reference to FIG. 1. In FIG. 1, a developing device is a contact two-component type developing device but the invention is not limited to this contact two-component type developing device, for example, there may also be employed a noncontact single component type developing device. In a developing device 102, a developing sleeve 120 (developer carrier) in which a cylindrical magnet 121 is non-rotatably disposed is disposed at the opening of a development vessel 110 containing a two-component developer, while being opposed to an organic photoreceptor 101. The developing sleeve 120 rotates in the counter direction to the organic photoreceptor 101 and conveys a developer which is adsorptive-held on the sleeve surface, to a developing section opposed to the organic photoreceptor. The magnet 121 has a development magnetic pole N1 on the side of the organic photoreceptor 101 and further has a first conveyance magnetic pole S3, a second conveyance magnetic pole N2, a third conveyance magnetic pole S2 and an abstracting magnetic pole S1 in the rotational direction from the magnetic pole N1 to the developing sleeve 120.

A developer within a developing vessel 110 is held on the developing sleeve 120 by the action of the abstracting pole S1 at the position (abstracting position) on the surface of the developing sleeve 120, corresponding to the abstracting magnetic pole S1 of the magnet 121 and, after the layer thickness being controlled by a developing blade 122, reaches the developing section. In the developing section, the developer forms a magnetic brush (developing brush) and develops a latent image on the photoreceptor 101.

The developer having a reduced toner concentration in development is returned to the development vessel 110 is returned to the development vessel 110 by the action of second and third conveyance magnetic poles S3 and N2, while being held on the developing sleeve, released from the developing sleeve 120 at the position and falls down at a position P (developer-falling position) onto the surface of the developing sleeve 120 which is in the middle between a third conveyance magnetic pole S2 and an abstracting magnetic pole S1. The developing sleeve 120 having released the developer attracts a new developer at an abstract position Q.

Under the developing sleeve 12 within the development vessel, a first stirring type conveyance member 123 is disposed and a second stirring type conveyance member 124 is also disposed across a partitioning wall 140. These first and second stirring type conveyance members 123 and 124 are each a screw type one which is provided with a helical screw blade 128 and a planar protrusion 130.

The developer released from the developing sleeve 12, having a reduced toner concentration fall down onto the first stirring type conveyance member 123, is conveyed in the axial direction, together with nearby developer, by the first stirring conveyance member 123, passes through the opening at the end of the partitioning wall 140 and is transferred to the second stirring conveyance member 124. The second stirring conveyance member 124 reverse-rotatively conveys the transferred developer and a toner fed through a feed opening 118 and returns them to the first stirring type conveyance member 123 through the opening at the other end of the portioning wall 140.

There will be described the preferred constitution of a counter development system. Hereinafter, in FIG. 1, the gap between the photoreceptor 101 at the developing section near the developing magnetic pole N1 and the developing sleeve 120 is referred to as the development gap (Dsd); and the height of a magnetic brush which is formed on the developing sleeve 120 by the developing magnetic pole N1, is referred to as the developing brush height (h).

### (1) Development Gap (Dsd): 0.2-0.6 mm

When the Dsd is from 0.2 to 0.6 mm, development is performed in a strong development electric-field, binding force of the magnetic carrier to a developing sleeve becomes greater, preventing adhesion of the magnetic carrier conveyed by the photoreceptor. Further, a development electric field is increased in the development gap, resulting in reduced edge effect and enhanced developability. Accordingly, thinning of a horizontal line image and lack of the rear end portion (development trouble of the rear end portion) are prevented and developability of a solid image is enhanced

### (2) Bite Depth (Bsd) of Magnetic Brush: 0.0-0.8 mm

The bite depth of a magnetic brush is defined as

Bsd=h−Dsd

where “h” is the height of a magnetic brush. A bite depth (Bsd) of 0.0 to 0.8 mm results in reduced contact with the developer in the development section and prevents developer from slipping through the gap between the developing sleeve 120 and the developing blade 122. Further, there can also be inhibited development troubles of an isolated dot image and an increase of granular appearance of halftone images, which are caused by non-uniform contact of the magnetic brush. When a bite depth of a magnetic brush is less than 0 (that is in the non-contact state), reduced density easily occurs and when the bite depth is more than 0.8 mm, a developer overflows from the nip portion, making it difficult to achieve uniform image formation.

### (3) Circumferential Speed Ratio (Vs/Vopc): 1.2-3.0

When the ratio of a circumferential speed of the developing sleeve (Vs) to that of the photoreceptor (Vopc) is from 1.2 to 3.0, enhanced developability can be achieved. An excessively high circumferential speed ratio results in excessively increased frequent contact of the magnetic brush on the developing sleeve to the photoreceptor and extremely increased mechanical pressure of the magnetic brush against the photoreceptor, and carriers easily adheres onto the photoreceptor, forming brush marks by the magnetic brush in the toner image on the photoreceptor. On the contrary, when the circumferential speed ratio is excessively lowered, the contact chance of the magnetic brush against the photoreceptor is excessively decreased, resulting in lowered developability. Thus, a circumferential speed ratio of less than 1.2 results in reduced density and a circumferential speed ratio of more than 3.0 causes problems such as scattering of toner particles, adhesion of carriers and lowering of durability of the developing sleeve. Contrarily, a circumferential speed ratio falling within the foregoing range can inhibit brush mark defects. Further, it can also be prohibited that excessively enhanced developability results in extreme accentuation of edge effects.

### (4) Development Bias Condition:

It is preferred that the difference between a surface potential (Vo) and a dc component (Vdc) of development bias applied to a developing sleeve (Vo−Vdc) is from 100 to 300 V, the dc component (Vdc) of said development bias is from 300 V to −650 V, the ac component (Vac) of the said development bias is from 0.5 to 1.5 kV, the frequency is from 3 to 9 kHz and Duty of 45 to 70% (time ratio on the developing side on a square wave), and being a square wave. Specifically, in a small two-component developing device composed of a developing sleeve having an outer diameter (φ) of not more than 30 mm and a photoreceptor having an outer diameter (φ) of not more than 60 mm, downsizing the developing sleeve lessens the developing nip widths leading to lowered developability, but this lowering of developability can be recovered by the foregoing bias conditions.

In the following; there will be described a process cartridge and an electrophotographic apparatus relating to the invention.

FIG. 2 illustrates a process cartridge and an electrophotographic image forming apparatus relating to the invention.

In FIG. 2, the numeral 1 designates a drum form organic photoreceptor (hereinafter also denoted simply as a photoreceptor), which is rotatably driven at a prescribed circumferential speed in the direction centered an axis C, as indicated by the arrow The organic photoreceptor 1 is subject to uniform electric-charging at a prescribed positive or negative electric potential by a charging means 2 and is subsequently subjected to enhanced modulation exposure light 3 (exposure means) corresponding to time-series electric digital image signals of objective image data outputted from an exposure means (not shown in the drawing). Thus, an electrostatic latent image corresponding to the objective image data is successively formed on the organic photoreceptor.

The formed electrostatic latent image is then subjected to toner development by a developing device 4 and the toner image formed and carried on the surface of the organic photoreceptor 1 is transferred by a transfer means 5 to a transfer material P which is fed from a paper supplying section (not shown in the drawing) in synchronization with rotation of the organic photoreceptor 1 and supplied between the organic photoreceptor 1 and a transfer means 5.

The transfer material P having received the toner image is separated from the organic photoreceptor surface, introduced to an image-fixing means 24, subjected to image fixing, and printed out as an image formation material (print or copy) to the outside of the apparatus.

The surface of the organic photoreceptor 1 after having transferred the toner image is cleaned by removing any remaining toner by a cleaning means 6 and then exposed to pre-exposure light Pex by a pre-exposure means (not shown in the drawing) to be repeatedly used for image formation. When the charging means 2 is a contact type charging means employing a charging roller or the like, such pre-exposure is not necessarily needed.

In the invention, of the foregoing organic photoreceptor 1, charging means 2, developing device 4, cleaning means 6 and the like, plural constituents are housed within a vessel PC and united as a process cartridge. This process cartridge is detachably installed within an electrophotographic apparatus body. For instance, at least one of the charging means 6, the developing device 4 and the cleaning means 6 is supported together with the organic photoreceptor 1 to form a cartridge, which is used as a process cartridge detachable from the apparatus body by using a guide means AN.

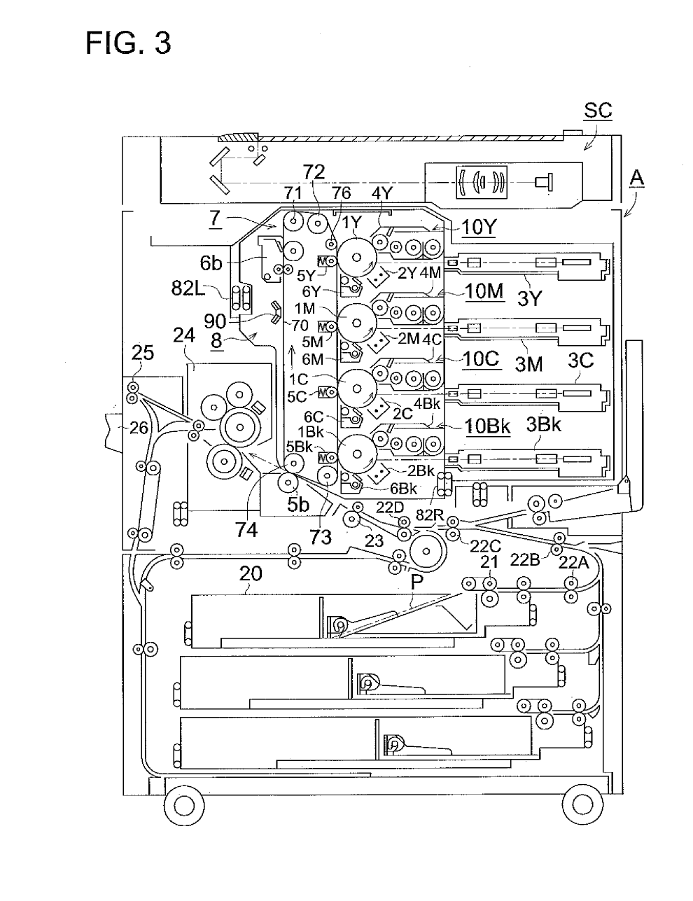

FIG. 3 illustrates a sectional view of an electrophotographic printer (hereinafter, also denoted simply as a printer) as a full-color image forming apparatus, showing one of the embodiments of the invention.

FIG. 3 illustrates a sectional view of a color image forming apparatus showing one of the embodiments of the invention.

This image forming apparatus is called a tandem color image forming apparatus, which is, as a main constitution, comprised of four image forming sections (image forming units) 10Y, 10M, 10C and 10Bk; an intermediate transfer material unit 7 of an endless belt form, a paper feeding and conveying means 21 and as a fixing means 24. Original image reading device SC is disposed in the upper section of image forming apparatus body A.

Image forming section 10Y to form a yellow image comprises a drum-form photoreceptor 1Y as the first photoreceptor; an electrostatic-charging means 2Y (electrostatic-charging step), an exposure means 3Y (exposure step), a developing means 4Y (developing step), a primary transfer roller 5Y (primary transfer step) as a primary transfer means; and a cleaning means 6Y, which are disposed around the photoreceptor 1Y.

An image forming section 10M to form a magenta image comprises a drum-form photoreceptor 1M as the second photoreceptor; an electrostatic-charging means 2M, an exposure means 3M and a developing means 4M, a primary transfer roller 5M as a primary transfer means; and a cleaning means 6M, which are disposed around the photoreceptor 1M.

An image forming section 10C to form a cyan image formed on the respective photoreceptors comprises a drum-form photoreceptor 1C as the third photoreceptor, an electrostatic-charging means 2Y, an exposure means 3C, a developing means 4C, a primary transfer roller SC as a primary transfer means and a cleaning means 6C, all of which are disposed around the photoreceptor 1C

An image forming section 10Bk to form a black image formed on the respective photoreceptors comprises a drum-form photoreceptor 1Bk as the fourth photoreceptor; an electrostatic-charging means 2Bk, an exposure means 3Bk, a developing means 4Bk, a primary transfer roller 5Bk as a primary transfer means and a cleaning means 6Bk which are disposed around the photoreceptor 1Bk.

The foregoing four image forming units 10Y, 10M, 10C and 10Bk are comprised of centrally-located photoreceptor drums 1Y, 1M, 1C and 1Bk; rotating electrostatic-charging means 2Y, 2M, 2C and 2Bk; imagewise exposure means 3Y, 3M, 3C and 3Bk; rotating developing means 4Y, 4M, 4C and 4Bk; and cleaning means 5Y, 5M, 5C and 5Bk for cleaning the photoreceptor drums 1Y, 1M, 1C and 1Bk.

The image forming units 10Y, 10M, 10C and 10Bk are different in color of toner images formed in the respective photoreceptors 1Y, 1M, 1C and 1Bk but are the same in constitution, and, for example, the image forming unit 10Y will be described below.

The image forming unit 10Y disposes, around the photoreceptor 1Y, an electrostatic-charging means 2Y (hereinafter, also denoted as a charging means 2Y or a charger 2Y), an exposure means 3Y, developing means (developing step) 4Y, and a cleaning means 5Y (also denoted as a cleaning blade 5Y, and forming a yellow (Y) toner image on the photoreceptor 1Y. In this embodiment, of the image forming unit 10Y, at least the photoreceptor unit 1Y, the charging means 2Y, the developing means 4Y and the cleaning means 5Y are integrally provided.

The charging means 2Y is a means for providing a uniform electric potential onto the photoreceptor drum 1Y. In the embodiment, a corona discharge type charger 2Y is used for the photoreceptor 1Y.

The imagewise exposure means 3Y is a mean which exposes, based on (yellow) image signals, the photoreceptor drum 1Y having a uniform potential given by the charger 2Y to form an electrostatic latent image corresponding to the yellow image. As the exposure means 3Y is used one composed of an LED arranging emission elements arrayed in the axial direction of the photoreceptor drum 1Y and an imaging device (trade name: selfoc lens), or a laser optical system.

When forming an electrostatic latent image on a photoreceptor according to the image forming method of the invention, image wise exposure is conducted preferably using a light beam having a spot area of not more than 2000 μm². Even when beam exposure of such a small diameter is conducted, the organic photoreceptor relating to the invention can achieve faithful image formation corresponding to such a spot area. The spot area is more preferably from 100 to 1000 μm². As a result, an electrophotographic image of superior gradation can be attained at not less than 800 dpi (in which “dpi” is the number of dots per inch or 2.54 cm).

The spot area of a light beam refers to an area corresponding to a region having a light intensity of 1/e² or more of the maximum peak intensity when the light beam is cut by the face vertical to the beam.

Light beams usable in the invention include a scanning optical system using a semiconductor laser and a solid scanner such as LED or a liquid crystal shutter. The light intensity distribution includes, for example, a Gauss distribution and a Lorentz distribution, in which an area up to 1/e² is a spot area.

Intermediate transfer unit 7 of an endless belt form is turned by plural rollers and has intermediate transfer material 70 as the second image carrier of an endless belt form, while being pivotably supported.

The individual color images formed in image forming sections 10Y, 10M, 10C and 10Bk are successively transferred onto the moving intermediate transfer material (70) of an endless belt form by primary transfer rollers 5Y, 5M, 5C and 5Bk, respectively, to form a composite color image. Recording member P of paper or the like, as a final transfer material housed in a paper feed cassette 20, is fed by paper feed and a conveyance means 21 and conveyed to a secondary transfer roller 5b through plural intermediate rollers 22A, 22B, 22C and 22D and a resist roller 23, and color images are secondarily transferred together on the recording member P. The color image-transferred recording member (P) is fixed by a heat-roll type fixing device 24, nipped by a paper discharge roller 25 and put onto a paper discharge tray outside a machine. Herein, a transfer support of a toner image formed on the photoreceptor, such as an intermediate transfer body and a transfer material collectively means a transfer medium.

After a color image is transferred onto a transfer material P by a secondary transfer roller 5b as a secondary transfer means, an intermediate transfer material 70 of an endless belt form which separated the transfer material P removes any residual toner by cleaning means 6b.

During the image forming process, the primary transfer roller 5Bk is always in contact with the photoreceptor 1Bk. Other primary transfer rollers 5Y, 5M and 5C are each in contact with the respectively corresponding photoreceptors 1Y, 1M and 1C only when forming a color image.

The secondary transfer roller 5b is in contact with the intermediate transfer material 70 of an endless belt form only when the transfer material P passes through to perform secondary transfer.

A housing 8, which can be pulled out from the apparatus body A through supporting rails 82L and 82R, is comprised of image forming sections 10Y, 10M, 10C and 10Bk and the endless belt intermediate transfer unit 7.

Image forming sections 10Y, 10M, 10C and 10Bk are aligned vertically The endless belt intermediate transfer material unit 7 is disposed on the left side of photoreceptors 1Y, 1M, 1C and 1Bk, as indicated in FIG. 2. The intermediate transfer material unit 7 comprises the endless belt intermediate transfer material 70 which can be turned via rollers 71, 72, 73 and 74, primary transfer rollers 5Y, 5M, 5C and 5Bk and cleaning-means 6b.

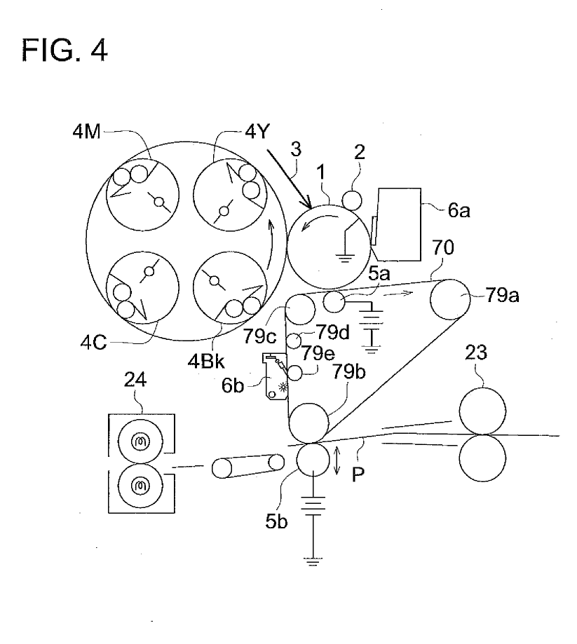

FIG. 4 illustrates a sectional view of a color image forming apparatus using an organic photoreceptor according to the invention (a copier or a laser beam printer which comprises, around the organic photoreceptor, an electrostatic-charging means, an exposure means, plural developing means, a transfer means, a cleaning means and an intermediate transfer means). The intermediate transfer material 70 of an endless belt form employs an elastomer of moderate resistance.

The numeral 1 designates a rotary drum type photoreceptor, which is repeatedly used as an image forming body, is rotatably driven anticlockwise, as indicated by the arrow, at a moderate circumferential speed.

The photoreceptor 1 is uniformly subjected to an electrostatic-charging treatment at a prescribed polarity and potential by a charging means 2 (charging step), while being rotated. Subsequently, the photoreceptor 1 is subjected to imagewise exposure via an imagewise exposure means 3 (imagewise exposure step) by using scanning exposure light of a laser beam modulated in correspondence to the time-series electric digital image signals of image data to form an electrostatic latent image corresponding to a yellow (Y) component image (color data) of the objective color image.

Subsequently, the electrostatic latent image is developed by a yellow toner of a first color in a yellow (Y) developing means 4Y: developing step (the yellow developing device). At that time, the individual developing devices of the second to fourth developing means 4M, 4C and 4Bk (magenta developing device, cyan developing device, black developing device) are in operation-off and do not act onto the photoreceptor 1 and the yellow toner image of the first color is not affected by the second to fourth developing devices.

The intermediate transfer material 70 is rotatably driven clockwise at the same circumferential speed as the photoreceptor 1, while being tightly tensioned onto rollers 79a, 79b, 79c, 79d and 79e.

The yellow toner image formed and borne on the photoreceptor 1 is successively transferred (primary transferred) onto the outer circumferential surface of the intermediate transfer material 70 by an electric field formed by a primary transfer bias applied from a primary transfer roller 5a to the intermediate transfer material 70 in the course of being passed through the nip between the photoreceptor 1 and the intermediate transfer material 70.

The surface of the photoreceptor 1 which has completed transfer of the yellow toner image of the first color is cleaned by a cleaning device 6a.

In the following, a magenta toner image of the second color, a cyan toner image of the third color and a black toner image of the fourth color are successively transferred onto the intermediate transfer material 70 and superimposed to form superimposed color toner images corresponding to the intended color image.

A secondary transfer roller 5b, which is allowed to bear parallel to a secondary transfer opposed roller 79b, is disposed below the lower surface of the intermediate transfer material 70, while being kept in the state of being separable.

The primary transfer bias for transfer of the first to fourth successive color toner images from the photoreceptor 1 onto the intermediate transfer material 70 is at the reverse polarity of the toner and applied from a bias power source. The applied voltage is, for example, in the range of +100 V to +2 kV.

In the primary transfer step of the first through third toner images from the photoreceptor 1 to the intermediate transfer material 70, the secondary transfer roller 5b and the cleaning means 6b for the intermediate transfer material are each separable from the intermediate transfer material 70.

The superimposed color toner image which was transferred onto the intermediate transfer material 70 is transferred to a transfer material P as the second image bearing body in the following manner. Concurrently when the secondary transfer roller 5b is brought into contact with the belt of the intermediate transfer material 70, the transfer material P is fed at a prescribed timing from paired paper-feeding resist rollers 23, through a transfer paper guide, to the nip in contact with the belt of the intermediate transfer material 70 and the secondary transfer roller 5b. A secondary transfer bias is applied to the second transfer roller 5b from a bias power source. This secondary bias transfers (secondary-transfers) the superimposed color toner image from the intermediate transfer material 70 to the transfer material P as a secondary transfer material. The transfer material P having the transferred toner image is introduced to a fixing means 24 and is subjected to heat-fixing.

An image forming apparatus usable in the invention is installed with a means for supplying a lubricant to the surface of a photoreceptor. Such a lubricant supplying means may be installed at an appropriate position near the photoreceptor but to make useful use of a space to install it, it may be installed employing a part of the space for a electric-charging means, a developing device and a cleaning means, as described in FIGS. 1-4. In the following, there will be exemplified a lubricant supplying means usable in combination with a cleaning means.

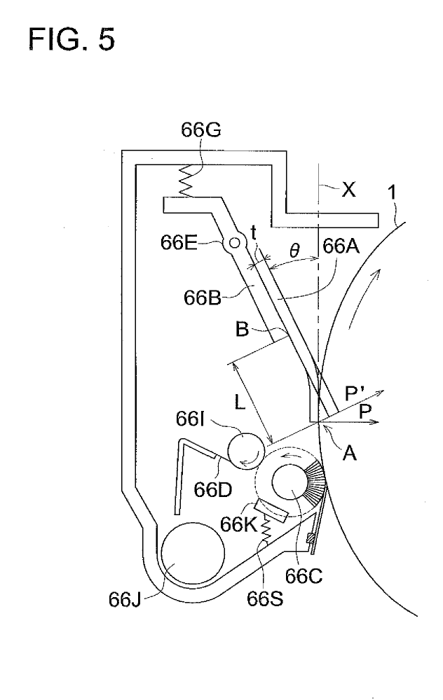

FIG. 5 illustrates configuration of a cleaning means relating to the invention.

This cleaning means is used as a cleaning means, designated by 6Y, 6M, 6C and 6K in FIG. 3. In FIG. 5, a cleaning blade 66A is fixed to a supporting member 66B. A rubber elastomer is used for the cleaning blade and examples of its constituting material include urethane rubber, silicone rubber, fluorinated rubber, chloroprene rubber and butadiene rubber. Of these, urethane rubber, which is superior in abrasion resistance to other rubbers, is specifically preferred.

The supporting member 66B is formed of a metal material or a plastic material. Preferred examples of such a metal material include a stainless steel plate, an aluminum plate, and a laminated damping steel sheet.

In the invention, the top of the cleaning blade is in contact with the surface of a photoreceptor, preferably while applying a load toward the opposite direction (or counter direction) to the rotation of the photoreceptor. As shown in FIG. 5, the top of the cleaning blade preferably forms a contact face when being in contact with the photoreceptor.

Preferred values of a contact load P and a contact angle θ of a cleaning blade to a photoreceptor are P=5-40 N/m and θ=5-35°. The contact load P is a vector value in the vertical direction of a contact force P′ when the cleaning blade 66A is brought into contact with a photoreceptor drum 1. The contact angle θ represents an angle between a tangent line X at a contact point A of the photoreceptor and a blade before being deformed (which is represented by a broken line in the drawing). Designation 66E is a rotating shaft which renders the supporting material rotatable, and designation 66G is a load spring.

A free length L of the cleaning blade represents the length of from the position of an end B of the supporting material 66B to the top of the blade before being deformed. The free length is preferably from 6 to 15 mm (L=6-15 mm). The thickness of a cleaning blade is preferably from 0.5 to 10 mm. The thickness of a cleaning blade is in the direction vertical to the contact face of the supporting material 66B, as shown in FIG. 5.

As shown in FIG. 5, a brush roll 66C is used as a cleaning means, which doubles as a means for supplying a lubricant. The brush roll functions as a means for supplying a lubricant to the photoreceptor as well as a function of removing any toner adhered to the photoreceptor 1 and recovering the toner removed by the cleaning blade 66A. The brush roll is in contact with the photoreceptor 1 and rotates at its contact point in the same direction as the propagation direction of the photoreceptor to remove a toner or paper dust on the photoreceptor, while conveying the toner removed by the cleaning blade 66A to recover the toner in a conveyance screw 66J. In the course thereof, a flicker 66I as a removing means is preferably brought into contact with the brush roll 66C to remove a toner or the like which has been transferred from the photoreceptor 1 to the brush roll 66C. Further, a toner attached to the flicker is removed by a scraper 66D and the toner is recovered in the conveyance screw 66J The thus recovered toner is externally taken out as a waste material or conveyed to the developing device through a recycling pipe (not shown in the drawing) as recycled toner to be reused. A metal pipe of such as stainless steel or aluminum is used as a preferred material for the flicker 66I. An elastic plate such as a phosphor bronze plate, polyethylene terephthalate plate or polycarbonate plate is used for the scraper 66D, which is preferably brought into contact in a counter system of the top forming an acute angle in the rotation direction of the flicker.

A lubricant 66K (which is a solid material such as zinc stearate) is placed with being pressed onto the brush roll by a spring load 66S and the brush brushes the lubricant with rotation to supply the lubricant to the surface of the photoreceptor. An electrically conductive or semi-conductive brush roll is used as the brush roll 66C.

A brush constituting material used for the brush roll used in the invention may be any one but preferably is a hydrophobic fiber-forming polymeric material exhibiting a high dielectric constant. Examples of such a polymeric material include a rayon, nylon, polycarbonate, polyester, methacrylic acid resin, acryl resin, polyvinyl chloride, polyvinylidene chloride, polypropylene, polystyrene, polyvinyl acetate, styrene-butadiene copolymer, vinylidene chloride-acrylonitrile copolymer, vinyl chloride-vinyl acetate copolymer, vinyl chloride-vinyl acetate-anhydrous maleic acid copolymer, silicone resin, silicone-alkyd resin, phenol formaldehyde resin, styrene-alkyd resin, and polyvinyl acetal (e.g., polyvinyl butyral). These resins may be used singly or in combination with two or more of them. Specifically, a rayon, nylon, polyester, acryl resin and polypropylene are preferred.

The foregoing brush employs an electrically conductive or semi-conductive one which contains an electrically low-resistant substance such as carbon to control a specific resistance.

The specific resistance of a brush hair of a brush roll is preferably within the range of 10¹ to 10⁶ Ωcm when measured at an ordinary temperature and humidity (26° C., 50% RH) with applying a voltage of 500 V to both ends of the brush hair of a 10 cm length. Thus, a brush roll preferably employs a conductive or semi-conductive brush hair exhibiting a specific resistance of 10¹ to 10⁶ Ωcm on a core material of such as stainless steel. A specific resistance lower than 10¹ Ωcm tends to cause banding due to discharging and a specific resistance of higher than 10⁶ Ωcm lowers the potential difference from a photoreceptor and tends to cause cleaning trouble.

The thickness of a single brush hair used for a brush roll is preferably from 5 to 20 deniers. A thickness of less than 5 deniers has no sufficient brushing power to remove surface-adhered materials- At a thickness of more than 20 deniers, such a brush becomes too rigid and scratches the surface of the photoreceptor and accelerates abrasion, leading to reduced life of the photoreceptor. The denier refers to a value representing a mass in gram (g) of a 9000 m long brush hair (fiber) forming the foregoing brush

A brush hair density of the foregoing brush is preferably from 4.5×10²/cm² to 2.0×10⁴/cm² (that is the number of brush hairs per cm²). A density of less than 4.5×10²/cm² results in lowered rigidity and weak brushing power, causing unevenness due to brushing and rendering it difficult to perform uniform removal. A density of more than 2.0×10⁴/cm² results in excessively high rigidity and strong brushing power, accelerating abrasion of the photoreceptor and causing image troubles such as fogging due to lowered sensitivity and streams due to scratching.

A brush roll used in the invention is preferably set to a penetration depth into the photoreceptor of from 0.4 to 1.5 mm. The penetration depth means a load applied to a brush which is caused by motion of a photoreceptor drum relative to the brush roll. The load corresponds to the scratching power by the brush when viewed from the photoreceptor drum and controlling its range means to be necessary to scratch the photoreceptor by an optimal power. The penetration depth refers to an internally penetrating length, assuming that a brush hair linearly penetrates into the photoreceptor surface without being bent when the brush is in contact with the photoreceptor.

Since, in a photoreceptor having a supplied lubricant, the scratching power of a brush is weak on the photoreceptor surface, a penetration depth of less than 0.4 mm renders it difficult to inhibit filming on the photoreceptor surface, due to a toner or paper powder, causing troubles such as image unevenness. On the other hand, a depth of more than 1.5 mm generates excessively high scratching power onto the photoreceptor surface, resulting in increased abrasion of the photoreceptor and producing problems such that fogging due to reduced sensitivity is caused, abrasion marks are generated on the photoreceptor surface or streaking defects occur on the image.

A core material of the core portion of the brush roll employs metals such as stainless steel and aluminum, paper or plastic but is not specifically limited to these.

A brush roll used in the invention is provided with a brush, preferably through an adhesive layer on the surface of a cylindrical core material.

Such a brush roll preferably rotates so that the contact portion moves in the same direction as the photoreceptor surface. In cases when the contact portion moving in the reverse direction, any toner removed by the brush roll drops and often causes staining on the transfer material or the apparatus.

When the photoreceptor and the brush roll move in the same direction, as described above, the surface speed ratio of the photoreceptor to the brush roll is preferably in the range of from 1:1.1 to 1:2.0. A slower rotation speed of the brush roll than that of the photoreceptor results in lowering of toner removing capability of the brush roll and tends to cause cleaning troubles, while a faster rotation speed of the brush roll than that of the photoreceptor results in excessive toner-removing capability, often causing blade bounding or peeling.

In the image forming apparatus used in the invention, as described above, a lubricant supplying means is brought into contact with the photoreceptor surface to supply a lubricant to the photoreceptor surface. Herein, the lubricant refers to a substance which is capable of adhering to the photoreceptor surface and lowering the surface energy of the photoreceptor. Specifically, it refers to a material capable of increasing by at least 1° of the contact angle (contact angle of pure water) on the photoreceptor surface when adhered to the photoreceptor.

### Measurement of Contact Angle

A contact angle on the photoreceptor surface is determined by measurement of a contact angle of pure water by use of a contact angle meter (C-DT/type A, produced by Kyowa Kaimenkagaku Co.) under an environment of 30° C. and 80% RH.

Lubricants usable in the invention are not limited to materials such as aliphatic acid metal salts or fluorinated resin but there is usable any material capable of increasing a contact angle (contact angle of pure water) on the photoreceptor surface by at least 1°.

A lubricant usable in the invention preferably is an aliphatic acid metal salt in terms of wettability and uniform film forming capability on the photoreceptor surface. Such an aliphatic acid metal salt preferably is a metal salt of a saturated or unsaturated aliphatic acid having at least 10 carbon atoms. Specific examples thereof include aluminum stearate, indium stearate, gallium stearate, zinc stearate, lithium stearate, magnesium stearate, sodium stearate, aluminum palmitate, and aluminum oleate, and of these, stearic acid metal salts are more preferred.

Specifically, of the foregoing aliphatic acid metal salts, an aliphatic acid metal salt of a high flow rate in a flow tester exhibits enhanced cleavability and is effective in forming a layer of an aliphatic acid metal salt on the surface of a photoreceptor relating to the invention. The flow rate is preferably not less than 1×10⁻⁷ and not more than 1×10⁻¹, and more preferably not less than 1×10⁻⁴ and not more than 1×10⁻². The flow rate in a flow tester can be measured by using Shimazu Flow Tester CFT-500 (produced by Shimazu Seisakusho Co.).

In addition to the foregoing solid materials, powdery fluorinated resin such as polyvinylidene fluoride or polytetrafluoroethylene is also preferred. These solid materials are optionally compressed and used preferably in the form of a plate or stick.

The image forming method of the invention is suitable for electrophotographic instruments such as an electrophotographic copier, a laser printer, a LED printer and a liquid crystal shutter type printer and is also broadly applicable to instruments employing electrophotographic techniques for displaying, recording, light-printing, print plate making and facsimiles.

### EXAMPLES

The present invention will be further described with reference to examples and comparisons but the invention is by no means limited to these. Unless otherwise noted, “part(s)” in examples presents part(s) by mass.

### Preparation of Photoreceptor 1:

Electrophotographic photoreceptor 1 was prepared in such a manner as below.

The surface of a cylindrical aluminum support was subjected to machine-cutting to prepare an electrically conductive support exhibiting a ten point surface roughness (Rz) of 1.5 μm.

### Intermediate Layer:

The following intermediate layer dispersion was diluted to two times with the same solvent and after allowed to stand over one day and night, was filtered with a filter (lysimesh 5 μm filter, produced by Nippon Pole Co.) to prepare a coating solution of an intermediate layer.

| | | |
|---|---|---|
| Polyamide resin CM 800 (produced | 1 | part |
| by Toray Co.) | | |
| Inorganic particles: titanium oxide* | 3 | parts |
| Methanol | 10 | parts |

*titanium oxide having a number average primary particle size of 35 nm and subjected silica alumina treatment and a methylhydrogen polysiloxane treatment

The foregoing composition was mixed and dispersed using a sand mill in a batch system for 10 hrs. to obtain an intermediate layer coating solution.

The thus prepared coating solution was coated on the support described above to achieve a dry layer thickness of 1.0 μm.

Charge generation layer (CGL):

| | |
|---|---|
| Charge generation material (CGM): Y-type | 24 parts |
| titanyl phthalocyanine | |
| Polyvinyl butyral resin S-LEC BL-1 | 12 parts |
| (produced by Sekisui Co., Ltd.) | |
| 2-Butanone/cyclohexanone 4/1 by vol. | 300 parts |

The foregoing composition was mixed and dispersed using a sand mill to prepare a coating solution for a charge generation layer. The coating solution was coated by the dip coating method on the intermediate layer to form a charge generation layer having a 0.5 μm dry thickness.

Charge transport layer (CTL):

| | |
|---|---|
| Charge transport material (CTM-1) | 225 parts |
| Binder resin (Table 1) | 300 parts |
| Dichloromethane | 2000 parts |
| Silicone oil (KF-54, produced by | 0.2 parts |
| Shinetsu Kagaku Co., Ltd.) | |

The foregoing composition was dissolved and dispersed to prepare a coating solution for a charge transport layer. The coating solution was coated on the charge generation layer and dried for 70 min. at 110° C. to form a charge transport layer having a 20.0 y thickness.

Outermost surface layer (OCL):

| | |
|---|---|
| Charge transport material (CTM-1) | 100 parts |
| Binder resin (Table 1) | 150 parts |
| Antioxidant (AO 2-1) | 5 parts |
| THF (tetrahydrofuran) | 2800 parts |
| Silicone oil (KF-50, produced by Shinetsu Kagaku Co., Ltd.) | 0.3 parts |

CTM-1

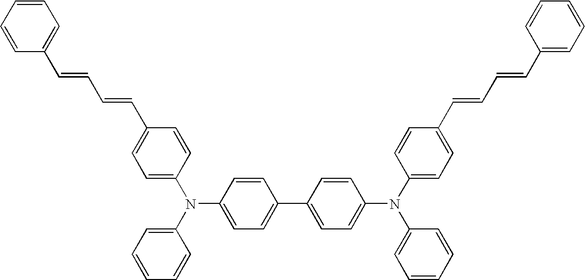

The foregoing composition was dissolved and dispersed to prepare a coating solution for an outermost surface layer. The coating solution was coated on the charge transport layer by a circular slide hopper type coating machine and dried at 110° C. for 70 min. to form a surface layer having a 5.0 μm dry thickness, whereby an electrophotographic photoreceptor 1.

### Preparation of Photoreceptors 2-4:

Electrophotographic photoreceptors 2 to 4 were each prepared similarly to the foregoing electrophotographic photoreceptor 1, except that binder resins of the charge transport layer and the surface layer were varied, as shown in Table 1.

In the electrophotographic photoreceptors 1 to 4, binder resins used in the charge transport layer and the outermost surface layer were identical.

### Preparation of Photoreceptors 5-7:

Electrophotographic photoreceptors 5 to 7 for comparison were each prepared similarly to the foregoing electrophotographic photoreceptor 1, except that binder resins of the charge transport layer and the surface layer were varied, as shown in Table 1.

### Preparation of Parent Particle 1 for Toner:

Parent particle 1 used for toner particles was prepared in the manner as below.

### Preparation of Resin Particle A:

### First Polymerization Step:

Into a 5 liter reaction vessel fitted with a stirrer, a temperature sensor, a condenser and a nitrogen introducing device was added 8 g of sodium dodecylsulfate dissolved in 3 liter of deionized water and the internal temperature was elevated to 80° C., while stirring at 230 rpm under nitrogen gas stream. After temperature elevation, 10 g of potassium persulfate dissolved in 200 g of deionized water was added thereto and the temperature was again elevated to 80° C., then, a monomer solution, as described below was added over 1 hr. and stirred for 2 hrs. with heating at 80° C. to perform polymerization to prepare resin particles. The thus prepared resin particles were designated as resin particle (1H).

| | |
|---|---|
| Styrene | 480 g |
| n-Butyl acrylate | 250 g |
| Methacrylic acid | 68.0 g |
| n-Octanethiol | 15.0 g |

### Second Polymerization Step:

Into a 5 liter reaction vessel fitted with a stirrer, a temperature sensor, a condenser and a nitrogen introducing device was added 7 g of sodium dodecyl ether sulfate dissolved in 800 ml of deionized water and after heating to 98° C., 260 g of the foregoing resin particle (1H) the following monomer solution which was dissolved at 90° C., was added thereto and dispersed over 1 hr. by using a mechanical dispersing machine having a circulation route, CLEARMIX (produced by M Technique Co., Ltd.) to prepare an emulsified dispersion containing oil droplets.

| | |
|---|---|
| Styrene | 223 g |
| n-Butyl acrylate | 142 g |
| n-Octanethiol | 1.5 g |
| Polyethylene wax (m.p.: 70° C.) | 190 g |

Subsequently, to the dispersion was added an initiator solution of 6 g of potassium persulfate dissolved in 200 ml of deionized water and stirred at 82° C. for 1 hr. to perform polymerization to obtain resin particles. The thus obtained resin particles were designated as resin particle (1HM).

### Third Polymerization Step:

Further, 11 g of potassium persulfate dissolved in 400 ml of deionized water was added and the following monomer mixture was added over 1 hr. at 82° C.:

| | |
|---|---|
| Styrene | 405 g |
| n-Butyl acrylate | 162 g |
| Methacrylic acid | 33 g |
| n-Octanethiol | 8 g |

After addition, the mixture was further stirred with heating over 2 hrs. to perform polymerization and then cooled to 28° C. to obtain resin particles. The thus obtained resin particles were designated as resin particle A.

A part of the resin particle was taken out, dried and measured, which exhibited a Tg of 21° C.

### Preparation of Resin Particle B:

Into a 5 liter reaction vessel fitted with a stirrer, a temperature sensor, a condenser and a nitrogen introducing device was added 2.3 g of sodium dodecylsulfate dissolved in 3 liter of deionized water and the internal temperature was elevated to 80° C., while stirring at 230 rpm under nitrogen gas stream. After temperature elevation, 10 g of potassium persulfate dissolved in 200 q of deionized water was added thereto and the temperature was again elevated to 80° C., then, a monomer solution, as described below was added over 1 hr, and stirred for 2 hrs. with heating at 80° C. to perform polymerization to prepare resin particles. The thus prepared resin particles were designated as resin particle B.

| | |
|---|---|
| Styrene | 520 g |
| n-Butyl acrylate | 210 g |
| Methacrylic acid | 68.0 g |
| n-Octanethiol | 16.0 g |

A part of the resin particle was taken out, dried and measured, which exhibited a Tg of 48° C.

### Preparation of Colorant Dispersion:

To 1600 ml of deionized water was added 90 g of sodium dodecylsulfate and dissolved with stirring. To this solution was gradually added 420 g of C.I Pigment Blue 15:3 and dispersed using a mechanical dispersing machine, CLEARMIX (produced by M Technique Co., Ltd.) to obtain a dispersion of colorant particles. The thus obtained dispersion was designated as colorant dispersion 1. The particle size of colorant particles of the colorant dispersion 1 was measured using an electrophoresis light scattering meter, ELS-800 (produced by Otsuka Denshi Co., Ltd.). The average particle size was 110 nm.

### Coagulation/Melt-Coalescence Step:

Into a 5 liter reaction vessel fitted with a stirrer, a temperature sensor, a condenser and a nitrogen introducing device were added 300 g (solid) of resin particle A, 1400 g of deionized water, 120 g of the foregoing colorant dispersion 1 and 3 g of sodium polyoxyethylene (2) dodecyl ether sulfate dissolved in 120 ml of deionized water, and after the liquid temperature was adjusted to 30° C., the pH was adjusted to 10 with an aqueous 5N sodium hydroxide solution. Subsequently, 35 g of magnesium chloride dissolved in 35 ml of deionized water was added over 10 min. with stirring at 30° C. After maintained for 3 min., the temperature was elevated to 90° C. over 60 min. and particle growth was allowed to continue, while maintaining the temperature at 90° C. During this stage, the particle size of coalesced particles was measured by Coulter Multisizer 3, when the volume-based median diameter reached 3.1 μm, 261 g of the dispersion of resin particle B was added and the particle growth was allowed to continue. When reached an intended particle size, an aqueous solution of 150 of sodium chloride dissolved in 600 ml of deionized water to terminate growth of particles, and coalescence between particles was allowed to proceed at 98° C. with stirring until the circularity of particles reached 0.965 with monitoring by FPIA-2100. Thereafter, the liquid temperature was cooled to 30° C. and hydrochloric acid was added thereto to adjust the pH to 4.0, and stirring was stopped.

### Washing and Drying Step:

Particles formed in the coagulation/coalescence step were subjected to solid-liquid separation by using a basket type centrifugal separator MARK III 60×40 (produced by Matsumoto Kikai Co., Ltd.) to form a wet cake of toner parent particles The wet cake was washed with deionized water of 45° C. by using the basket type centrifugal separator until the filtrate reached an electric conductivity of 5 μS/cm and then dried in Flash Jet Drier (produced by Seishin Kigyo Co.) until a moisture content reached 0.5% by mass, whereby parent particle 1 for toner was prepared.

### Preparation of Parent Particle 2 for Toner:

Parent particle 2 for toner was prepared similarly to the parent particle 1, except that in the monomer composition of the second polymerization step of the resin particle A, styrene and n-butyl acrylate were changed to 240 g and 121 g, respectively, and in the monomer composition of the third polymerization step, styrene, n-butyl acrylate and methacrylic acid were changed to 423 g, 144 g and 33 g, respectively.

### Preparation of Parent Particle 3 for Toner:

Parent particle 3 for toner was prepared similarly to the parent particle 1, except that in the monomer composition of the second polymerization step of the resin particle A, styrene and n-butyl acrylate were changed to 265 g and 103 g, respectively, and in the monomer composition of the third polymerization step, styrene, n-butyl acrylate and methacrylic acid were changed to 423 g, 144 g and 33 g, respectively.

### Preparation of Parent Particle 4 for Toner:

Parent particle 4 for toner was prepared similarly to the parent particle 1, except that in the Monomer composition of the second polymerization step of the resin particle A, styrene and n-butyl acrylate were changed to 270 g and 91 g, and in the monomer composition of the third polymerization step, styrene, n-butyl acrylate and methacrylic acid were changed to 423 g, 144 g and 33 g, respectively.

### Preparation of Parent Particle 5 for Toner:

Parent particle 5 for toner was prepared similarly to the parent particle 1, except that in the monomer composition of the second polymerization step of the resin particle A, styrene and n-butyl acrylate were changed to 274 g and 91 g, respectively, and in the coagulation/coalescence step, the dispersion of rein B was added in an amount of 300 g

### Preparation of Parent Particle 6 for Toner:

Parent particle 5 for toner was prepared similarly to the parent particle 1, except that in the coagulation/coalescence step, the dispersion of resin particle B was not added.

### Preparation of Toners 1-6:

To each of the thus obtained parent particles 1-6 were added hydrophobic silica (number average primary particle size of 12 nm) and hydrophobic titania (number average primary particle size of 20 nm) were added in amounts of 1% by mass and 0.3% by mass, respectively, and mixed by a Henschel mixer to prepare toners 1-5. The thus prepared toners 1-6 were measured with respect to Tg according to the afore-described method. The thus measure Tg values are shown below.

It was impossible to prepare a toner exhibiting a Tg of less than 16° C. according to the foregoing method.

Tg of toner
Toner 1: 22° C.
Toner 2: 33° C.
Toner 3: 40° C.
Toner 4: 44° C.
Toner 5: 46° C.
Toner 6: 19° C.

### Preparation of Developers 1-6:

Toner particles of Table 1 were each mixed with a silicone-coated ferrite carrier having a volume average particle size of 40 μm to prepare developers 1-6, each having a toner content of 6%.

### Evaluation 1 (Counter-Development System)

Evaluation was made in counter-developing system The obtained photoreceptors were each mounted to an image forming apparatus in which a commercially available composite copier, bizhub PRO C500 (produced by Konica Minolta business Technologies Inc.) was modified to a counter-developing system and process conditions as below, a cleaning means shown in FIG. 5 was mounted as a cleaning means for a photoreceptor, and lubricants (A-B, as shown below) and photoreceptors were combined, as shown in Table 1 to evaluate color images obtained by using the prepared color toners. Using an original image having a white background, a solid image portion, a halftone image portion and character image portion, continuous-copying onto a A4 sheet was conducted. Specifically, Printing of 300,000 sheets was performed, while being taken out at the start and every 5000 sheets. Evaluation items and evaluation criteria are as follows.

### Evaluation Condition;

Evaluation was conducted under the following process conditions of a counter-developing system,
Photoreceptor linear speed: 280 mm/sec
Penetration depth of magnetic brush: 0.30 mm
Development gap (Dsd): 0.30 mm
ac component of development bias (Aac): 1.0 KVₚ₋ₚ
Circumferential ratio of developing sleeve to Photoreceptor ((Vs/Vopc): 2.0
dc component of development bias (Vdc): −500 V

Difference between surface potential (Vd) of photoreceptor and dc component (Vd) of development bias (Vo−Vdc): 200 V
Frequency: 5 KHz
Duty: 50% square wave

Development: reversed development using a two-component developer of polymerization toners of yellow, magenta, cyan and black toners each having an average particle size of 6.5 μm and containing external additives of a 0.3 μm hydrophobic titanium oxide and a 15 nm hydrophobic silica, used for the respective development means (4Y, 4M, 4C , 4Br).

### Kind of Lubricant:

A: solid lubricant of zinc stearate,
B: solid lubricant of aluminum stearate,
C: solid lubricant of aluminum oleate,
D: solid lubricant composed of solid-formed fine-particulate polytetrafluoroethylene (in which fine-particulate polytetrafluoroethylene is dispersed in a thermoplastic polymer and solidified and a polytetrafluoroethylene content is 65% of the whole).

Printing was conducted at room temperature to perform evaluation.

### Image Evaluation

### Image Density:

The image density of prints at the start and at the time of 300,000th sheet was each measured by using a densitometer RD-918 (produced by Macbeth Co.). The image density was represented by a relative value, based on the density of a print sheet being 0.0 and evaluated by the following criteria:
A: a density of not less than 1.3 (a superior level),
B: a density of not less than 1.0 and less than 1.3 (an acceptable level in practice),
C: a density of less than 1.0 (an unacceptable level in practice).

### Fogging:

The fog density of prints at the start and at the time of 300,000th sheet was each measured by using a densitometer RD-918 (produced by Macbeth Co.). The fog density was represented by a relative value, based on the reflection density of a A4 sheet being 0.000 and evaluated by the following criteria:
A: a density of less than 0.010 (a superior level),
B: a density of not less than 0.010 and less than 0.020 (an acceptable level in practice),
C: a density of not less than 0.020 (an unacceptable level in practice).

### Density Lowering of Top Portion

A halftone image was prepared at the time of the 300,000th print sheet and evaluated based on the following criteria:
A: no lowering of a density at the top portion was observed and a halftone image was clearly reproduced (excellent),
B: a halftone image was clearly reproduced but a density lowering of less than 0.04 (reflection density) was observed at the top portion (acceptable in practice),
C: a density lowering of not less than 0.04 (reflection density) was observed in halftone images unacceptable in practice).

### White Spot:

A: no image defect in the form of a minute white spot occurred and no deposition of fine particle was observed on a photoreceptor,
B: slight deposition of fine particle was observed on a photoreceptor but no problem in halftone images (acceptable in practice),
C: white spot defects were observed in halftone images (unacceptable in practice).

### Cleaning Capability:

While image formation of 10,000 sheets was conducted, the presence/absence of image defect due to cleaning trouble of a photoreceptor was visually evaluated, based on the following criteria:

A: no cleaning trouble occurs (excellent),

C: cleaning troubles occur (unacceptable in practice). Evaluation results are shown in Table 1.

TABLE 1

| Experiment | Photoreceptor | Binder | | | Image | Fog | Density | White | Cleaning | |
|---|---|---|---|---|---|---|---|---|---|---|
| No. | No. | Resin | Toner | Lubricant | Density | Density | Lowering | Spot | Capability | Remark |
| 1 | 1 | P-1 | 1 | A | A | A | A | A | A | Inv. |
| 2 | 2 | P-6 | 1 | A | A | A | A | A | A | Inv. |
| 3 | 3 | P-7 | 1 | A | A | A | A | A | A | Inv. |
| 4 | 4 | P-8 | 1 | A | A | A | A | A | A | Inv. |
| 5 | 1 | P-1 | 2 | B | A | A | A | A | A | Inv. |
| 6 | 1 | P-1 | 3 | C | A | A | A | A | A | Inv. |
| 7 | 1 | P-1 | 4 | D | A | B | B | B | A | Inv. |
| 8 | 1 | P-1 | 5 | A | B | B | B | C | C | Comp. |
| 9 | 1 | P-1 | 6 | A | B | B | B | B | B | Inv. |
| 10 | 1 | P-1 | 1 | — | C | C | B | B | C | Comp. |
| 11 | 5 | PC-1 | 1 | A | C | B | B | C | C | Comp. |
| 12 | 6 | PC-2 | 1 | A | C | B | C | C | C | Comp. |
| 13 | 7 | PC-3 | 1 | A | C | C | C | C | C | Comp. |

Binder Resin
P-1

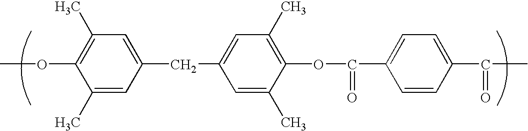

P-6

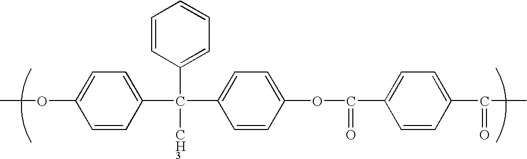

P-7

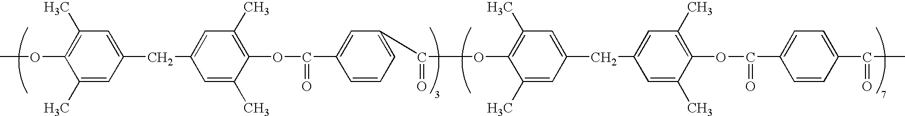

P-8

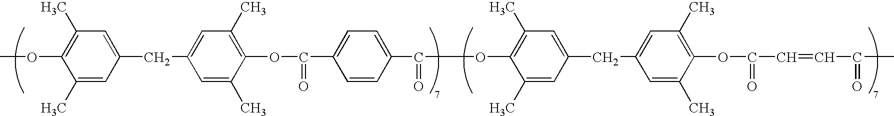

PC-1

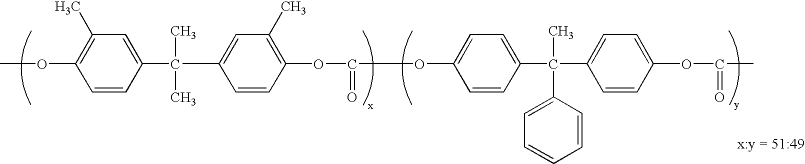

PC-2

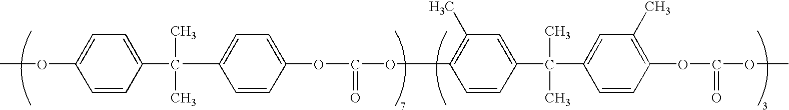

PC-3

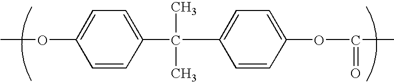

In image evaluation which was conducted in a counter development system, as is apparent from Table 1, experiment Nos. 1-8 in which were each combined with supplying a lubricant to the surface of an organic photoreceptor resulted superior characteristics in all of image density, fog density, density lowering of the top portion, white spot and cleaning capability. It is noted that a toner exhibiting a Tg of 20 to 40° C. resulted in enhanced improvements. On the contrary, experiment No. 10 having no combination with supplying a lubricant caused fogging and cleaning trouble. It is further noted that photoreceptor 8 combined with a toner exhibiting a Tg of 46° C. and photoreceptors Nos. 5-7 caused filming on the photoreceptor surface and resulted in reduced image density and image defects such as a white spot, even when a lubricant was supplied to the photoreceptor surface and a developer of a toner exhibiting a Tg of 20-40° C. was used.

### Evaluation 2 (Parallel Development System)

Evaluation was also conducted in a parallel development system in which a photoreceptor and a developing sleeve were allowed to move in the same direction.

Evaluation Condition:
Linear speed of photoreceptor; 280 mm/sec
Linear speed of developing sleeve: 560 mm/sec

As a result of evaluation, clear difference between the invention and comparison, as was observed in the foregoing evaluation 1i was not observed in evaluation 2. In was further noted that although neither density lowering of at the top portion nor fogging was observed, reduced image density and electrophotographic images of insufficient densities resulted, compared to the counter development system.

What is claimed is:

1. An image forming method comprising the steps of:
(a) electrically charging a cylindrical photoreceptor,
(b) forming an electrostatic latent image on the charged photoreceptor,
(c) developing the electrostatic latent image formed on the photoreceptor with a developer comprising a toner to form a toner image,
(d) transferring the toner image to a transfer medium and
(e) removing a residual toner on the photoreceptor to clean the photoreceptor,
wherein in step (c), a cylindrical developing sleeve carrying a developer is brought into contact with the photoreceptor with rotating the developing sleeve in the counter direction to rotation of the photoreceptor, and a lubricant is supplied to the photoreceptor and the photoreceptor comprises a uppermost surface layer containing a polyarylate having a structure unit represented by the following formula (1) and the toner comprises toner particles exhibiting a glass transition temperature of from 16 to 44° C.: 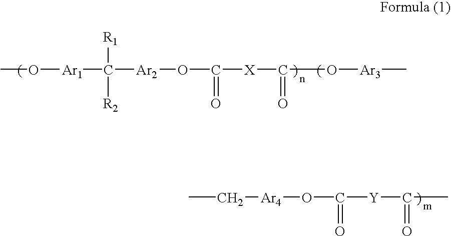
wherein Ar₁ to Ar₄ are each an unsubstituted or substituted phenylene group; X and Y are each a divalent linkage group selected from the group of a divalent saturated or unsaturated aliphatic hydrocarbon group, an unsubstituted or substituted phenylene group, an unsubstituted or substituted naphthylene group and an unsubstituted or substituted biphenylene group; R₁ and R₂ are each a hydrogen atom, an unsubstituted or substituted alkyl group, an unsubstituted or substituted aryl group, an unsubstituted or substituted acyloxy group, or an unsubstituted or substituted arylsulfoxy group, provided that R₁ and R₂ may combine with each other to form a ring; n is an integer of 30 to 400 and m is an integer of 0 to 200, provided that when m is not 0, a repeating unit enclosed by n in a parenthesis and a repeating unit enclosed by m in a parenthesis are not the same.

2. The image forming method of claim 1, wherein in the formula (1), Ar₁ to Ar₄ are each a substituted phenylene group which is substituted by a substituent selected from the group consisting of a halogen atom, a cyano group, a nitro group, a hydrocarbon group, a hydrocarbon group substituted by a halogen atom, an alkoxy group, an alkoxy group substituted by a halogen atom and an alkylthio group; the divalent linkage group represented by X or Y is a substituted phenylene, naphthylene or biphenylene group which is substituted by a substituent selected from the group consisting of an aliphatic hydrocarbon group having 2 to 6 carbon atoms which is unsubstituted or substituted by a substituent selected from the group consisting of a fluorine atom, a chlorine atom, a bromine atom, a methyl group, a methoxy group, a trifluoromethyl group and a trifluoromethoxy group, a hydrocarbon group which is unsubstituted of substituted by a halogen atom, a cyano group, a nitro group, a hydrocarbon group or a halogen atom, an alkoxy group which is unsubstituted or substituted by a halogen atom, and an alkylthio group.

3. The image forming method of claim 1, wherein in the formula (1), Ar₁ to Ar₄ are each a phenylene group substituted by a hydrocarbon group; the divalent linkage group represented by X or Y is a phenylene group which is unsubstituted or substituted by a hydrocarbon group, or a vinyl group; n is an integer of 50 to 300 and m is an integer of 10 to 100.

4. The image forming method of claim 1, wherein the toner is a polymerization toner.

5. The image forming method of claim 4, wherein the polymerization toner is produced by a process of suspension polymerization or emulsion polymerization.

6. The image forming method of claim 1, wherein the photoreceptor rotates at a linear rate of 280 mm/sec.

7. The image forming method of claim 1, wherein the lubricant is supplied to the photoreceptor by a brush roll.

8. The image forming method of claim 1, wherein the lubricant is a metal salt of a carboxylic acid or a fluorinated resin.

9. The image forming method of claim 1, wherein the lubricant is a metal salt of a saturated or unsaturated carboxylic acid having at least 10 carbon atoms.

10. The image forming method of claim 1, wherein the lubricant is zinc stearate.
